(19) United States
(12) Patent Application Publication
(10) Pub. No.: US 2007/0207360 A1
(43) Pub. Date: Sep. 6, 2007

(54) ELECTROLYTE MEMBRANE, MEMBRANE ELECTRODE ASSEMBLY, AND FUEL CELL

(76) Inventors: Jun Tamura, Yokohama-shi (JP); Yoshihiko Nakano, Yokohama-shi (JP); Wu Mei, Yokohama-shi (JP); Kazuhiro Yasuda, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/744,267

(22) Filed: May 4, 2007

Related U.S. Application Data
(63) Continuation of application No. PCT/JP07/50854, filed on Jan. 15, 2007.

(30) Foreign Application Priority Data
Jan. 20, 2006 (JP) 2006-012888

(51) Int. Cl. H01M 8/10

(52) U.S. Cl. 429/33

(57) ABSTRACT

An electrolyte membrane includes a porous membrane and a proton conductive inorganic material loaded in the porous membrane. The proton conductive inorganic material has a super strong acidity. The proton conductive inorganic material contains a first oxide and a second oxide bonded to the first oxide. The first oxide contains an element X formed of at least one element selected from the group consisting of Ti, Zr, Hf, Nb, Al, Ga, In, Si, Ge, Sn and Ce. The second oxide contains an element Y formed of at least one element selected from the group consisting of V, Cr, Me, W and B.

### CROSS-REFERENCE TO RELATED APPLICATIONS

This is a Continuation Application of PCT Application No. PCT/JP2007/050854, filed Jan. 15, 2007, which was published under PCT Article 21(2) in English.

This application is based upon and claims the benefit of priority from prior Japanese Patent Application No. 2006-012888, filed Jan. 20, 2006, the entire contents of which are incorporated herein by reference.

### BACKGROUND OF THE INVENTION

1. Field of the Invention

The present invention relates to an electrolyte membrane, a membrane electrode assembly using the electrolyte membrane, and a fuel cell equipped with the membrane electrode assembly.

2. Description of the Related Art

In a fuel cell, a fuel electrode used as an anode is mounted to one side of a proton conductive electrolyte membrane, and an oxidizing electrode used as a cathode is mounted to the other side of the electrolyte membrane. A fuel such as hydrogen or methanol is supplied to the anode. An oxidizing agent is supplied to the cathode. The fuel is electrochemically oxidized on the anode to generate protons and electrons. The electrons flow into the external circuit. On the other hand, the protons are allowed to migrate through the proton conductive electrolyte membrane to arrive at the cathode. The protons are allowed to react with the oxidizing agent and with the electrons coming from the external circuit to form water, with the result that it is possible to obtain an electric power.

It is desirable for the proton conductive electrolyte membrane to exhibit a high proton conductivity and a low methanol permeability. Perfluoro sulfonic acid polymer is known as a material of an organic polymer based proton conductive electrolyte membrane. To be more specific, the material of the organic polymer based proton conductive electrolyte membrane comprises a tetrafluoro ethylene-perfluoro vinyl ether copolymer used as a base material and a sulfonic acid group used as an ion exchange group. The particular polymer includes, for example, NAFION (a registered trade mark of Du Pont Inc.). Where a perfluoro sulfonic acid polymer is used as an electrolyte membrane, the amount of the water contained in the membrane is decreased by the drying to lower the proton conductivity of the electrolyte membrane. A severe water supervision is required in the case of using the perfluoro sulfonic acid polymer in the vicinity of 100° C. at which a high output can be obtained. As a result, the system of the fuel cell is made highly complex. It should also be noted that the perfluoro sulfonic acid polymer, which has a cluster structure, has a sparse molecular structure. As a result, the organic liquid fuel such as methanol is allowed to permeate through the electrolyte membrane including the perfluoro sulfonic acid polymer to arrive at a region on the side of the cathode. In other words, a methanol cross-over phenomenon is generated. Where the methanol cross-over phenomenon has been generated, the liquid fuel and the oxidizing agent, which are supplied into the fuel cell, are allowed to perform reactions directly, resulting in failure to obtain electric power. It therefore follows that a problem of lack of stable output results. Naturally, extensive research is being conducted on a material for replacing the perfluoro sulfonic acid polymer.

JP-A 2004-158261 (KOKAI) discloses an electrolyte membrane prepared by mixing a metal oxide supporting sulfuric acid and exhibiting a solid super strong acidity with a polymer material having an ion exchange group. The metal oxide supporting sulfuric acid and exhibiting a solid super strong acidity is obtained by applying a heat treatment to the surface of a metal oxide containing at least one element selected from the group consisting of zirconium, titanium, iron, tin, silicon, aluminum, molybdenum and tungsten to immobilize a sulfate group to the surface of the oxide. In the metal oxide supporting sulfuric acid, the proton conductivity is exhibited by the sulfate group immobilized on the surface. In the metal oxide supporting sulfuric acid, however, the sulfate group is released by the hydrolysis to lower the proton conductivity. Therefore, the metal oxide supporting sulfuric acid is unstable when used as a proton conductive solid electrolyte in a fuel cell in which water is generated in the process of the power generation, particularly, in a fuel cell using a liquid fuel. Such being the situation, the metal oxide supporting sulfuric acid is not considered suitable for a stable power supply over a long period of time.

On the other hand, JP-A 2004-103299 (KOKAI) discloses an electrolyte membrane prepared by loading an organic polymer electrolyte in a sheet made essentially of an inorganic fiber. Since an organic polymer electrolyte is used, a methanol cross-over phenomenon is generated in the electrolyte membrane. Also, where the fuel cell is operated over a long time under high temperatures not lower than 100° C., the ion exchange group such as a sulfonic acid group is decomposed and released to the outside to lower the power output. Such being the situation, the electrolyte membrane is not considered suitable for a stable power supply over a long period of time.

PCT National Publication No. 2004-515351 (U.S. 20040038105A) discloses an electrolyte membrane for a fuel cell, being an inorganic porous carrier supporting an inorganic ionic conductor and impregnated with an ionic liquid. To be more specific, it is taught that alumina particles are baked to a glass woven fabric used as the inorganic porous carrier by using a solution containing zirconia, followed by baking titania particles to the carrier by using a solution containing aluminum and vanadium.

### BRIEF SUMMARY OF THE INVENTION

According to a first aspect of the present invention, there is provided an electrolyte membrane comprising:

a porous membrane; and

a proton conductive inorganic material loaded in the porous membrane, having a super strong acidity, and containing a first oxide and a second oxide bonded to the first oxide, the first oxide containing an element X formed of at least one element selected from the group consisting of Ti, Zr, Hf, Nb, Al, Ga, In, Si, Ge, Sn and Ce, and the second oxide containing an element Y formed of at least one element selected from the group consisting of V, Cr, Me, W and B.

According to a second aspect of the present invention, there is provided a membrane electrode assembly comprising:

a fuel electrode;

an oxidizing electrode; and

an electrolyte membrane arranged between the fuel electrode and the oxidizing electrode and including a porous membrane and a proton conductive inorganic material which is loaded in the porous membrane, has a super strong acidity, and contains a first oxide and a second oxide bonded to the first oxide, the first oxide containing an element X formed of at least one element selected from the group consisting of Ti, Zr, Hf, Nb, Al, Ga, In, Si, Ge, Sn and Ce, and the second oxide containing an element Y formed of at least one element selected from the group consisting of V, Cr, Mo, W and B.

According to a third aspect of the present invention, there is provided a fuel cell, comprising:

a fuel electrode;

an oxidizing electrode; and

an electrolyte membrane arranged between the fuel electrode and the oxidizing electrode and including a porous membrane and a proton conductive inorganic material which is loaded in the porous membrane, has a super strong acidity, and contains a first oxide and a second oxide bonded to the first oxide, the first oxide containing an element X formed of at least one element selected from the group consisting of Ti, Zr, Hf, Nb, Al, Ga, In, Si, Ge, Sn and Ce, and the second oxide containing an element Y formed of at least one element selected from the group consisting of V, Cr, Mo, W and B.

### BRIEF DESCRIPTION OF THE SEVERAL VIEWS OF THE DRAWING

FIG. 1 is a cross sectional view schematically showing the construction of a fuel cell according to a third embodiment;

FIG. 2 is a cross sectional view schematically showing the construction of the electrolyte membrane used in the fuel cell shown in FIG. 1; and

FIG. 3 is a cross sectional view schematically showing the construction of another fuel cell according to the third embodiment.

### DETAILED DESCRIPTION OF THE INVENTION

Some embodiments of the present invention will now be described in the following with reference to the accompanying drawings. In the following description directed to the embodiments and Examples of the present invention, the same members of the apparatus, which have a common construction, are denoted by the same reference numerals to omit the overlapping description.

### FIRST EMBODIMENT

An electrolyte membrane for a fuel cell according to a first embodiment of the present invention will now be described first.

The electrolyte membrane for the fuel cell according to the first embodiment of the present invention comprises a proton conductive inorganic material having a super strong acidity and a porous membrane. The electrolyte membrane performs mainly the function of transferring the protons generated by the oxidizing reaction of the fuel performed on the fuel electrode used as an anode to reach the oxidizing electrode used as a cathode. The electrolyte membrane also performs the function of a separator for physically shielding the fuel on the fuel electrode from the oxidizing agent gas on the oxidizing electrode.

The proton conductive inorganic material having a super strong acidity is formed of an inorganic oxide comprising a first oxide containing an element X formed of at least one element selected from the group consisting of Ti, Zr, Hf, Nb, Al, Ga, In, Si, Ge, Sn and Ce and a second oxide that is bonded to the first oxide and contains an element Y formed of at least one element selected from the group consisting of V, Cr, Mo, W and B. The inorganic oxide noted above is called herein an oxide having a super strong acidity.

The accurate proton conducting mechanism in the oxide having a super strong acidity has not yet been clarified. It is considered reasonable to understand that the first oxide, i.e., oxide A, is chemically bonded to the second oxide, i.e., oxide B, with the result that a Lewis acid point is formed within the structure of the oxide B, and the Lewis acid point is hydrated to form a Brönsted acid point, thereby forming a conducting field of protons. It is also considered reasonable to understand that, where the oxide having a super strong acidity has an amorphous structure, the amorphous structure serves to promote the formation of the Lewis acid point.

In addition to the proton forming reaction performed in the Lewis acid point, attention should also be paid to the situation that the number of molecules of the entrained water required for the proton conduction can be decreased. As a result, it is possible to obtain a high power generation without performing a severe water supervision in the power generating stage. It follows that it is possible to lower the cell resistance by allowing the electrolyte membrane to contain the oxide having a super strong acidity, thereby increasing the maximum power generation amount of the fuel cell.

In some cases, the oxide B exhibits a solubility in water, though the solubility of the oxide B depends on the element contained in the oxide B and on the environment of pH. The solubility in water of the oxide B can be suppressed by forming a chemical bond between the oxide B and the oxide A having a low solubility in water. The chemical bond noted above can be formed between the oxide A and the oxide B by applying a heat treatment to a mixture comprising the oxide A and the oxide B. As a result, it is possible to increase the stability of the oxide having a super strong acidity against water and a liquid fuel. And, it is possible to prevent the contamination of the other fuel cell materials and apparatus by the ions generated from the dissolved oxide particles B. It follows that it is possible to impart a reliability over a long time to the fuel cell. Further, the manufacturing cost of the fuel cell can be suppressed by using a cheap oxide A as a base material.

The chemical coupling between the oxide A and the oxide B can be confirmed by the analysis using an analytical apparatus such as an X-ray diffraction method (XRD), an electron probe microanalysis (EPMA), an X-ray photoelectron spectroscopy (XPS), an energy dispersive X-ray analysis (EDX), and a transmitting electron microscope (TEM). In, for example, the X-ray diffraction method (XRD), it is possible to obtain a diffraction pattern of a crystal lattice of a crystalline material. It is possible to confirm the presence or absence of the coupling of the crystalline materials by comparing the diffraction pattern before the reaction and the diffraction pattern after the reaction. On the other hand, where the materials to be coupled are amorphous materials, it is impossible to confirm the coupling of the oxide materials based on the diffraction pattern. Therefore, the presence of the amorphous material can be confirmed from the composition analysis using an apparatus such as an atomic absorption spectrometry. For the composition analysis, it is possible to use, for example, an energy dispersive X-ray analysis (EDX), an electron probe microanalysis (EPMA), or an X-ray photoelectron spectroscopy (XPS).

In the proton conductive inorganic material according to the first embodiment of the present invention, it suffices for the oxide A and the oxide B to be chemically coupled with each other. The crystallinity of any of the oxide A and the oxide B is not limited. However, it is desirable for each of the oxide A and the oxide B to be amorphous in view of the promotion of the Lewis acid point formation, the possibility of the contribution to the improvement of the acidity, the manufacturing cost, and the ease of the manufacturing process. Further, it is more desirable for the oxide B to be amorphous and for the oxide A to be crystalline. It is also possible for the crystallinity of each of the oxide A and oxide B to be opposite to that exemplified above. To be more specific, it is also possible for each of the oxide A and the oxide B to be crystalline. Further, it is possible for the oxide B to be crystalline and for the oxide A to be amorphous.

The oxide A and the oxide B are chemically coupled with each other to obtain the proton conductive inorganic material according to the first embodiment of the present invention. The coupling can be performed by, for example, the baking. It is desirable for the proton conductive inorganic material to contain as a third component an oxide C containing an element Z formed of at least one kind of the element selected from the group consisting of Y, Sc, La, Sm, Gd, Mg, Ca, Sr and Ba. The oxide C of the third component is used as a structure stabilizer of the proton conductive inorganic material. Where the oxide C is further contained in the proton conductive inorganic material, the oxide A and the oxide B can be coupled with each other without fail by the baking to obtain a sufficient acidity. Also, the oxide C permits suppressing the scattering of the constituting oxides in the case of elevating the baking temperature to obtain a desired composition and, thus, to suppress the decrease of the proton conductive sites. Further, if the baking is applied, a change is brought about in the crystal structure of the oxide composition, which is caused by the increase in the crystallinity of the oxide. As a result, stress is generated in the proton conductive inorganic material. However, the stress generated can be moderated by the addition of the element Z. Since the coupling force between the oxide A and the oxide B can be increased by the addition of the element Z, it is possible to suppress the separation of the oxide A and the oxide B. Such being the situation, it is possible to realize a sufficient acidity and a sufficient proton conductivity. At the same time, it is possible to suppress the cracking of the proton conductive inorganic material when the inorganic material is loaded into a porous membrane and to suppress the dropping of the proton conductive inorganic material from the base material.

It is desirable for the amount of the element Z contained in the proton conductive inorganic material to fall within a range of 0.01 to 40 mol % on the basis that the sum of the element X, the element Y and the element Z is set at 100 mol %. Where the amount of the element Z contained in the proton conductive inorganic material is not smaller than 0.01 mol %, it is possible to improve the stability of the proton conductive inorganic material. Also, where the amount of the element Z noted above is not larger than 40 mol %, it is possible to maintain the solid super strong acidity of the proton conductive inorganic material. In other words, the stability of the proton conductive inorganic material can be improved without impairing the solid super strong acidity of the proton conductive inorganic material by setting the amount of the element Z to fall within a range of 0.01 to 40 mol %. It is more desirable for the amount of the element Z to fall within a range of 0.1 to 25 mol %.

It is desirable for the element ratio (Y/X) of the element Y of the oxide B to the element X of the oxide A to fall within a range of 0.0001 to 20. Where the element ratio (Y/X) is not smaller than 0.0001, it is possible to increase the conductive sites of protons to make it possible to obtain a sufficient proton conductivity. Also, where the element ratio (Y/X) is not larger than 20, it is possible to decrease the proton conductive sites covered with the oxide particles B containing the element Y. As a result, it is possible to obtain a sufficient proton conductivity. In other words, a high proton conductivity can be obtained by setting the element ratio (Y/X) to fall within a range of 0.0001 to 20. It is more desirable for the element ratio (Y/X) of the element Y of the oxide B to the element X of the oxide A to fall within a range of 0.01 to 5.

The proton conductive inorganic material according to the first embodiment of the present invention can be obtained by, for example, applying a heat treatment to a precursor solution containing the elements constituting an oxide having a super strong acidity. To be more specific, prepared in the first step is a solution containing the element X and the element Y collectively constituting the oxide having a super strong acidity, i.e., the element X being at least one element selected from the group consisting of Ti, Zr, Hf, Nb, Al, Ga, In, Si, Ge, Sn and Ce, and the element Y being at least one element selected from the group consisting of V, Cr, Me, W and B. The solution is prepared in a manner to form a mixture of the oxide A and the oxide B having a desired composition. In the next step, the mixture is dried to permit the precursor of each of the oxide A and the oxide B to be deposited, followed by baking the dried mixture to form a chemical bond between the oxide A and the oxide B, thereby obtaining a proton conductor. It is possible to prepare the precursor solution containing the element X and the element Y by using as the raw materials an aqueous solution of a chloride, nitrate, hydroacid, or oxo acid salt or an alcoholic solution of a metal alkoxide.

It is desirable for the precursor solution noted above to be subjected to a heat treatment under temperatures falling within a range of 200 to 1,000° C. If the temperature for the heat treatment is not lower than 200° C., a sufficient chemical bond can be formed between the oxide A and the oxide B, with the result that the proton conductivity of the oxide having a super strong acidity thus obtained can be increased sufficiently. Also, if the temperature for the heat treatment is not higher than 1,000° C., the fusing reaction with the porous membrane can be suppressed to make it possible to obtain a high proton conductivity. At the same time, the volume shrinkage can be diminished, with the result that the stress can be moderated to prevent the breakage of the electrolyte membrane. It follows that an electrolyte membrane having a high proton conductivity can be manufactured at a high yield by setting the temperature for the heat treatment to fall within a range of 200 to 1,000° C. It is more desirable for the temperature for the heat treatment to fall within a range of 400 to 700° C. Incidentally, if the heat treatment is performed at 200° C., which is not sufficiently high, it is necessary to perform the heat treatment for a long time for forming a chemical bond between the oxide A and the oxide B. However, if the heat treatment is performed under high temperatures in the vicinity of 1,000° C., the chemical bonds can be formed easily between the oxide A and the oxide B, with the result that the electrolyte membrane having a high proton conductivity can be synthesized by the heat treatment of a short time.

In the electrolyte membrane according to the first embodiment of the present invention, the heat treatment is carried out to permit a porous membrane to hold the proton conductive inorganic material, thereby making it unnecessary to use a binder. As a result, it is possible to suppress the difficulty that the continuity of the proton conductive inorganic materials is impaired by the binder. It should also be noted that, since the surface of the proton conductive inorganic material is not covered with the binder, it is possible to supply sufficiently the water required for the proton generation to the proton conductive inorganic material. Further, since the binder that tends to absorb and transmit methanol is not contained in the electrolyte membrane, it is possible to suppress the methanol cross-over phenomenon of the electrolyte membrane.

The proton conductive inorganic material according to the first embodiment of the present invention exhibits a solid super strong acidity. It should be noted that the degree of dissociation of the proton can be denoted by the degree of acidity. The acid strength of a solid acid can be represented by the Hammett acidity function H₀. In the case of sulfuric acid, the Hammett acidity function H₀ is −11.93. It is desirable for the oxide having a super strong acidity to exhibit a solid super strong acidity having a Hammett acidity function H₀, which satisfies H₀<−11.93. Also, in the oxide having a super strong acidity according to the first embodiment of the present invention, it is possible for the Hammett acidity function H₀ to be increased to −20.00 by optimizing the synthesizing method. It follows that it is desirable for the Hammett acidity function H₀ of the oxide having a super strong acidity to satisfy −20.00≦H₀<11.93.

The porous membrane for holding the proton conductive inorganic material is baked after the porous membrane is impregnated with the precursor solution of the oxide having a super strong acidity. Thus, the porous membrane is required to exhibit a high resistance to heat. Since it is desirable for the temperature for the heat treatment to fall within a range of 200 to 1,000° C., it is desirable for the porous membrane to be formed of a heat resistant polymer or an inorganic material. To be more specific, it is desirable for the porous membrane to be formed of a porous film of a fluorine-based polymer such as polytetrafluoro ethylene, a porous film of a hydrocarbon-based polymer such as polyamide or polyimide, or a porous membrane such as an unwoven fabric or a woven fabric, which is formed of a glass fiber or a silica fiber. The heat resistant porous material exemplified above is widely available on the market and, thus, is not particularly limited.

An oxide having a super strong acidity, which is a proton conductive electrolyte, is loaded in a porous membrane. Needless to say, the loading amount of the oxide having a super strong acidity in the porous membrane can be increased with increase in the porosity of the porous membrane to increase the proton conductivity of the electrolyte membrane. However, if the porosity of the porous membrane is excessively high, the mechanical strength of the porous membrane is lowered. As a result, the electrolyte membrane obtained by loading the oxide having a super strong acidity in the porous membrane is rendered brittle and, thus, tends to be cracked. Such being the situation, it is desirable for the porous membrane to have a porosity falling within a range of 30 to 95%. It is more desirable for the porous membrane to have a porosity falling within a range of 50 to 90%.

The proton conductive material forms the routes for transferring the protons and, thus, it is desirable for the proton conductive inorganic material to have a connection within the porous membrane. The connection of the proton conductive inorganic material can be improved by setting the loading rate of the oxide having a super strong acidity at a level not lower than 80% based on the porosity of the porous membrane. As a result, it is possible to obtain a high proton conductivity. At the same time, it is possible to suppress the methanol cross-over through the non-loaded pore portion. It should also be noted that the proton conductivity can be increased and the methanol cross-over can be lowered by setting ideally the loading rate of the porous membrane in the pore portion at substantially 100%. The electrolyte membrane can be obtained by, for example, drying and baking the loaded precursor solution of the oxide having a super strong acidity. Since the volume shrinkage is brought about without fail if a solid material is precipitated from the solution, it is considered difficult to set the loading rate of the oxide having a super strong acidity at 100%. However, it is possible to increase the loading rate to a level close to 100% by repeating the operations of loading the precursor solution of the oxide having a super strong acidity and performing the heat treatment or by utilizing the precursor solution having a high concentration of the oxide having a super strong acidity. It follows that it is desirable for the loading rate of the oxide having a super strong acidity to fall within a range of 80 to 98% of the pore portion of the porous membrane.

The thickness of the proton conductive electrolyte membrane is not particularly limited. However, in order to obtain an electrolyte membrane practically satisfactory in the mechanical strength, the permeability of the liquid fuel and the proton conductivity, it is desirable for the proton conductive electrolyte membrane to have a thickness not smaller than 10 μm. Also, it is desirable for the proton conductive electrolyte membrane to have a thickness not larger than 300 μm in order to lower the membrane resistance. Particularly, in order to lower the internal resistance of the fuel cell, it is desirable for the proton conductive electrolyte membrane to have a thickness of 10 to 100 μm. The thickness of the proton conductive electrolyte membrane can be controlled by controlling the thickness of the porous membrane. For example, it is possible to decrease the thickness of the porous membrane by heating and pressing in advance the porous membrane by using, for example, a hot press machine. However, the method of controlling the thickness of the proton conductive electrolyte membrane is not particularly limited.

The fuel cell comprising the electrolyte membrane according to the first embodiment of the present embodiment described above can be driven with a high stability over a wide temperature region ranging between room temperature and a high temperature in the vicinity of 150° C. Also, it is possible to increase the proton conductivity of the electrolyte membrane. Further, the methanol permeability can be lowered.

### SECOND EMBODIMENT

The second embodiment of the present embodiment is directed to a membrane electrode assembly comprising a fuel electrode, an oxidizing electrode, and an electrolyte membrane arranged between the fuel electrode and the oxidizing electrode. The construction and the effect of the electrolyte membrane are substantially equal to those described previously in conjunction with the first embodiment of the present embodiment.

The electrode for the fuel cell comprises a catalyst layer containing a redox catalyst, a proton conductor and a binder, e.g., an organic polymer binder. The catalyst layer provides mainly the reaction site of the redox reaction for the fuel and the oxidizing agent that is carried out on the electrode for the fuel cell. The catalyst layer also provides the transfer layers of the protons and the electrons formed and consumed in the redox reaction. Each of the fuel electrode and the oxidizing electrode is formed of a gas-permeable structure such as a porous body. It is possible for each of the fuel gas, the liquid fuel and the oxidizing agent gas to be transferred through any of the fuel electrode and the oxidizing electrode.

In order to promote the oxidizing reaction of the fuel on the fuel electrode and the reducing reaction of oxygen on the oxidizing electrode, a metal catalyst supported on an electron conductive catalyst carrier such as carbon is used. The metal catalyst includes, for example, platinum, gold, silver, palladium, iridium, rhodium, ruthenium, iron, cobalt, nickel, chromium, tungsten, molybdenum, manganese and vanadium. It is possible for these metal catalysts to be used singly or in the form of an alloy comprising a plurality of different metal catalysts. In particular, platinum exhibits a high catalytic activity and, thus, is used widely in many cases. Also, it suffices for the carrier material supporting the metal catalyst to exhibit an electron conductivity. In many cases, a carbon material is used as the carrier material. To be more specific, the carbon material noted above includes, for example, a carbon black such as a furnace black, a channel black, and an acetylene black, as well as an activated charcoal and graphite.

The method for allowing the metal catalyst to be supported by a catalyst carrier such as a carbon material is not particularly limited. For example, a carbon material is dispersed in a solution having a material including the metal element used as the metal catalyst dissolved therein. The solution noted above includes, for example, an aqueous solution of a chloride, a nitrate, a hydroacid or an oxo acid salt or an alcoholic solution of a metal alkoxide. Then, the solvent is removed from the solution to permit the metal catalyst particles to be deposited on the surface of the catalyst carrier, followed by applying a heat treatment to the catalyst carrier under a reducing atmosphere to permit the metal catalyst to be supported by the catalyst carrier. It is possible for the metal particles used as the metal catalyst to have a diameter falling within a range of 1 nm to 50 nm. It is also possible for the amount of the metal catalyst to fall within a range of 0.01 mg/cm² to 10 mg/cm² under the state of the electrode.

The electrolyte used in the electrode catalyst layer is not particularly limited. It is possible to use, for example, NAFION (registered trademark of a perfluoro sulfonic acid polymer electrolyte manufactured by Du Pont Inc.). The polymer electrolyte exemplified above also performs the function of a binder. However, in order to obtain a stable output of the fuel cell even under a high temperature, it is advisable to use an electrode including a catalyst layer in which the catalyst particles are bonded to the oxide particles having a super strong acidity by using an organic polymer.

The proton conductive inorganic oxide particles can be used as the oxide particles that have a super strong acidity and are contained in the catalyst layer included in each of the fuel electrode and the oxidizing electrode. The proton conductive inorganic oxide particles noted above comprise an oxide carrier containing the element X consisting of at least one kind of the element selected from the group consisting of Ti, Zr, Hf, Nb, Al, Ga, In, Si, Ge, Sn and Ce and oxide particles supported on the surface of the oxide carrier and containing the element Y consisting of at least one kind of the element selected from the group consisting of V, Cr, Mo, W and B. It is desirable for the proton conductive inorganic oxide particle to further contain as a third component an oxide C containing the element Z consisting of at least one kind of the element selected from the group consisting of Y, Sc, La, Sm, Gd, Mg, Ca, Sr and Ba. The oxide C noted above acts as a structure stabilizer of the proton conductive inorganic oxide particles.

The oxide particle that has a super strong acidity and is contained in the catalyst layer forms a route for transferring the protons to the electrolyte membrane. Therefore, it is desirable for the oxide particles having a super strong acidity to exhibit a sufficient connection. To be more specific, it is desirable for the oxide particles having a super strong acidity to have 0.01 to 50 mg/cm² in the electrode.

In order to fix the metal catalyst or both the catalyst carrier and the oxide particles having a super strong acidity to the catalyst layer, it is desirable to use an organic polymer as a binder. The polymer material used is not particularly limited. However, it is possible for the polymer material used to include, for example, polystyrene, polyether ketone, polyether ether ketone, polysulfone, polyether sulfone or another engineering plastic material. It is also possible to use a polymer material prepared by doping the polymer material exemplified above with sulfonic acid, phosphoric acid or another proton carrier. It is also possible for the proton carrier to be chemically bonded to or immobilized on the polymer material exemplified above. Further, it is possible to use a polymer material such as perfluoro sulfonic acid, which exhibits a proton conductivity.

The oxide particle having a super strong acidity is capable of exhibiting the function of the proton conductor in the case where water is present on the surface. It is possible to supply a sufficiently large amount of water to the oxide particle having a super strong acidity by selecting a hydrophilic polymer as the polymer material, with the result that it is possible to realize a catalyst layer having a high proton conductivity. It is desirable for the hydrophilic polymer to be formed of an organic polymer having an equilibrium moisture absorption rate not lower than 5% under temperatures not lower than 20° C. It is desirable for the hydrophilic polymer to have any of a hydroxyl group, a carboxyl group, an ether bond, an amide bond and an ester bond in the polymer structure. To be more specific, the hydrophilic polymer material includes, for example, polyvinyl alcohol, polyacrylic acid, polyacrylic acid ester, polyvinyl pyrrolidone, polyethylene glycol, polyamide, polyester and polyvinyl acetate. Incidentally, for measuring the equilibrium absorption rate noted above, a sample membrane is left to stand for one week under an environment of a constant temperature of not lower than 20° C. and a relative humidity not lower than 95% to permit the moisture absorption amount of the sample membrane to reach the state of equilibrium. Then, the weight of the sample membrane was measured. Further, the weight of the sample membrane thus measured is compared with the weight of the sample membrane measured 2 hours after the drying of the sample membrane at 105° C. to obtain the equilibrium absorption rate noted above based on the difference in weight of the sample membrane noted above.

Since it is desirable to form a catalyst layer structure maintaining a high proton conductivity and a high electric conductivity while maintaining a porosity, it is desirable to determine appropriately the mixing ratio of the metal catalyst or the catalyst carrier to the oxide particles having a super strong acidity and the organic polymer binder. It is desirable for the weight ratio (P/C) to fall within a range of 0.001 to 0.5. P is a weight of the polymer material. C is a weight of the catalyst layer. Where the weight ratio (P/C) noted above is set to fall within the range given above, it is possible to increase the connection of each of the proton conductive inorganic oxide particles and the metal catalyst particles, with the result that it is possible to improve both the proton conductivity and the electric conductivity.

It is possible for the electrode to be formed of the catalyst layer alone or to be formed by forming a catalyst layer on another supporting material. The method of forming the electrode is not particularly limited. For example, it is possible to prepare a slurry by dispersing the metal catalyst or the catalyst carrier, the oxide particles having a super strong acidity or the organic polymer binder in water or an organic solvent such as an alcohol, followed by coating a supporting material with the slurry thus prepared and subsequently drying and baking the coated slurry to form a desired catalyst layer. The temperature for the heat treatment is not higher than about 200° C. in general in view of the decomposing temperature of the organic polymer binder of the hydrocarbon system. However, in the case of using a fluorine-based organic polymer having a high decomposing temperature, it is possible for the catalyst layer to withstand the heating under high temperatures not higher than 400° C. It is considered reasonable to understand that, in the case of using a hydrophilic organic polymer as the organic polymer binder, an oxidizing reaction or a dehydrating reaction is carried out between the proton conductive inorganic oxide particle and the hydrophilic organic polymer by the heat treatment performed at temperatures not higher than 200° C. In addition, an interaction of the hydrogen bond and the crystallization of the hydrophilic organic polymer are generated to prevent the hydrophilic organic polymer from being swollen or dissolved in the solvent, though the detailed mechanism has not yet been clarified. Regarding polyvinyl alcohol, as a result of infrared spectroscopic analysis (IR), it appears that the hydrophilic hydroxyl group in the polyvinyl alcohol is oxidized by the solid super strong acid to be converted into a hydrophobic ketone group. It is thus necessary to carry out the heat treatment under temperatures at which the organic polymer is not decomposed nor deteriorated. To be more specific, it is desirable to carry out the heat treatment under temperatures not higher than 200° C.

The supporting body is not particularly limited. For example, it is possible to use the electrolyte membrane as the supporting body. In this case, a membrane electrode assembly is obtained by forming a catalyst layer on the electrolyte membrane. Alternatively, it is possible to form a catalyst layer on paper, felt or cloth made of a carbon material and exhibiting a gas permeability and an electric conductivity. In this case, the catalyst layer and the electrolyte membrane collectively form a membrane electrode assembly.

The electrolyte membrane can be bonded to the electrode by using an apparatus capable of heating and pressing the electrolyte membrane and the electrode. In this case, it suffices for the pressing temperature to be not lower than the glass transition temperature of the polymer used in the electrolyte membrane. To be more specific, it suffices for the pressing temperature to fall within a range of, for example, 100 to 400° C. Also, it suffices for the pressing pressure to fall within a range of for example, 5 to 200 kg/cm², though the pressing pressure depends on the hardness of the electrode used.

The membrane electrode assembly according to the second embodiment of the present embodiment makes it possible to produce a stable output over a wide temperature region ranging between room temperature and a high temperature in the vicinity of 150° C. Further, it is possible to increase the proton conductivity of the electrolyte membrane. Still further, it is possible to lower the methanol permeability. In particular, the protons and the electrons can be migrated promptly by using the oxide having a super strong acidity in any of the fuel electrode, the electrolyte membrane and the oxidizing electrode.

### THIRD EMBODIMENT

A fuel cell according to a third embodiment of the present embodiment comprises the membrane electrode assembly according to the second embodiment of the present embodiment described above.

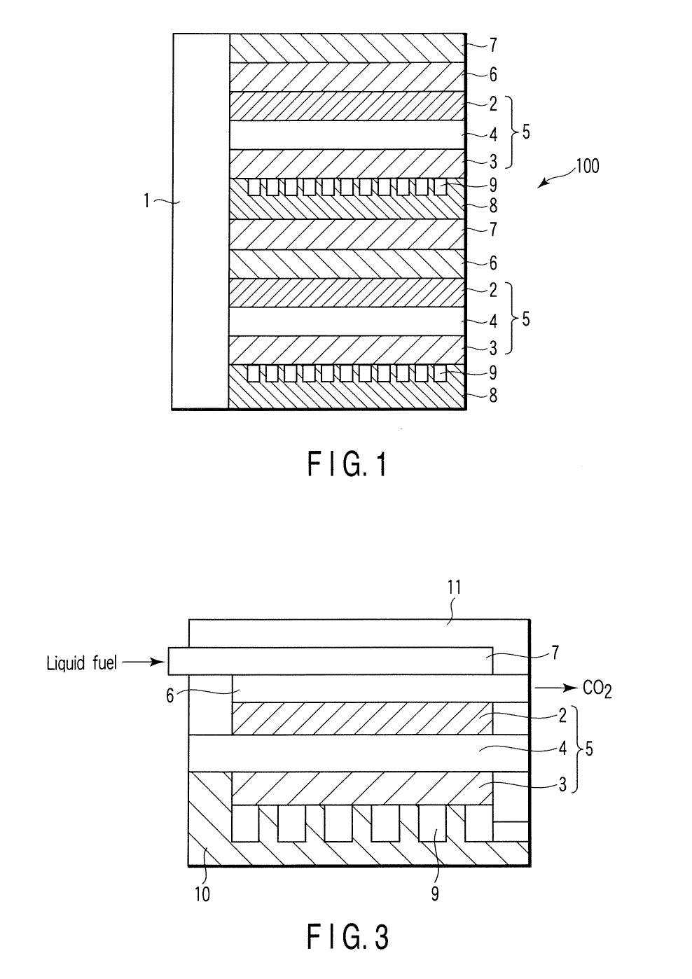

The fuel cell according to the third embodiment of the present embodiment will now be described with reference to the accompanying drawings. Specifically, FIG. 1 is a cross sectional view schematically showing the construction of the fuel cell according to the third embodiment of the present embodiment.

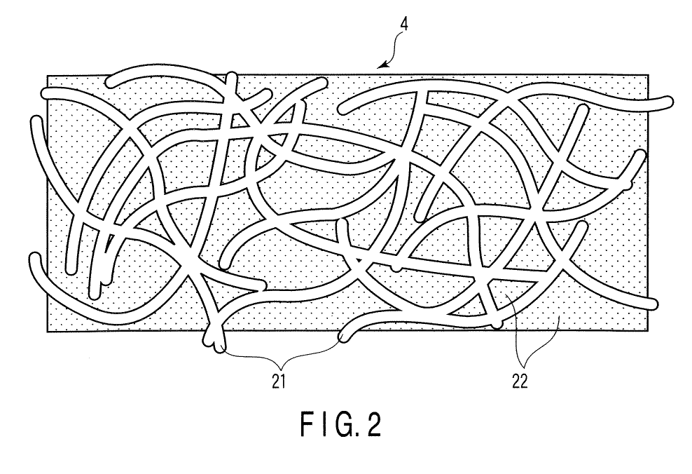

A stack 100 of the liquid fuel cell shown in FIG. 1 is formed by stacking a plurality of unit cells one upon the other. A fuel introducing passageway 1 is arranged on the side surface of the stack 100. A liquid fuel is supplied into the fuel introducing passageway 1 from a liquid fuel tank (not shown) through an introducing pipe (not shown). It is desirable for the liquid fuel to include methanol. For example, it is possible to use an aqueous solution of methanol and methanol itself as the liquid fuel. Each unit cell comprises a membrane electrode assembly (electromotive section) 5 including a fuel electrode (or anode) 2, an oxidizing electrode (or cathode) 3, and an electrolyte membrane 4 interposed between the fuel electrode 2 and the oxidizing electrode 3. It is desirable for each of the fuel electrode 2 and the oxidizing electrode 3 to be formed of a conductive porous material to permit electrons, the fuel and the oxidizing agent gas to be circulated through the fuel electrode 2 and the oxidizing electrode 3. FIG. 2 is a cross sectional view schematically showing the construction of the electrolyte membrane 4 prepared by loading an oxide having a super strong acidity 22 in a glass paper 21, i.e., unwoven fabric of a glass fiber, used as a porous membrane.

Each unit cell further comprises a fuel evaporating section 6 stacked on the fuel electrode 2, a fuel permeating section 7 stacked on the fuel evaporating section 6, and a cathode separator 8 stacked on the oxidizing electrode 3. The fuel permeating section 7 performs the function of holding the liquid fuel. The liquid fuel is supplied from the fuel introducing passageway 1. The fuel evaporating section 6 serves to guide the evaporated component of the liquid fuel held by the fuel permeating section 7 into the fuel electrode 2. An oxidizing agent gas supply channel 9 for circulating the oxidizing gas is formed as a continuous groove in that surface region of the cathode separator 8 which is positioned to face the oxidizing electrode 3. Also, the cathode separator 8 plays the role of connecting the adjacent electromotive sections 5 to each other in series.

Where the stack 100 is formed by stacking the unit cells as shown in FIG. 1, each of the separator 8, the fuel permeating section 7 and the fuel evaporating section 6 also performs the function of a current collecting plate for transmitting the generated electrons. Such being the situation, it is desirable for each of the separator 8, the fuel permeating section 7 and the fuel evaporating section 6 to be formed of an electrically conductive material such as a porous body containing carbon.

As described above, the separator 8 included in the unit cell shown in FIG. 1 also performs the function of a channel for allowing the oxidizing gas to flow within the unit cell. The number of parts of the fuel cell can be decreased by using the member 8, hereinafter referred to as a “channel-performing separator”, which performs the functions of both the separator and the channel. It follows that the fuel cell can be further miniaturized. Alternatively, it is possible to use an ordinary channel in place of the separator 8.

For supplying a liquid fuel from the fuel storing tank (not shown) into the liquid fuel introducing passageway 1, it is possible to permit the liquid fuel stored in the fuel storing tank to be subjected to a free fall such that the liquid fuel is introduced into the liquid fuel introducing passageway 1. This method is advantageous in that the liquid fuel can be introduced without fail into the liquid fuel introducing passageway 1, though there is a structural limitation that it is necessary to mount the fuel storing tank at a position higher than the upper surface of the stack 100. It is also possible to utilize the capillary action of the liquid fuel introducing passageway 1 for supplying the liquid fuel from the fuel storing tank into the liquid fuel introducing passageway 1. In the case of employing the method utilizing the capillary action of the liquid fuel introducing passageway 1, it is unnecessary to set the position of the connecting point between the fuel storing tank and the liquid fuel introducing passageway 1, i.e., the fuel inlet port formed in the liquid fuel introducing passageway, at a point higher than the upper surface of the stack 100.

It should be noted, however, that, in order to permit the liquid fuel introduced by the capillary action into the liquid fuel introducing passageway 1 to be supplied by utilizing the capillary action into the fuel permeating section 7, it is desirable for the capillary action for guiding the liquid fuel into the fuel permeating section 7 to be larger than the capillary action for introducing the liquid fuel into the liquid fuel introducing passageway 1. Incidentally, the liquid fuel introducing passageway is not limited to the liquid fuel introducing passageway 1 extending along the side surface of the stack 100. It is also possible to form an additional liquid fuel introducing passageway 1 on the other side surface of stack 100.

It should be noted that the fuel storing tank noted above can be formed detachable from the cell body. In this case, the fuel cell can be continuously operated for a longer time by simply replacing the fuel storing tank. Also, the liquid fuel can be supplied from the fuel storing tank into the liquid fuel introducing passageway 1 by utilizing free fall, by employing the construction that liquid fuel is pushed out by the inner pressure within the fuel storing tank, or by employing the construction that the fuel is taken out of the fuel storing tank by utilizing the capillary force of the liquid fuel introducing passageway 1.

The liquid fuel introduced into the liquid fuel introducing passageway 1 by the method described above is supplied into the fuel permeating section 7. The type of the fuel permeating section is not particularly limited as long as the liquid fuel is held inside the fuel permeating section 7 and the evaporated fuel is supplied selectively into the fuel electrode 2 through the fuel evaporating section 6. For example, it is possible for the fuel permeating section 7 to include a liquid fuel passageway and to further include a gas-liquid separating membrane at the interface with the fuel evaporating section 6. Further, where the liquid fuel is supplied into the fuel permeating section 7 by utilizing the capillary action and without using an auxiliary apparatus, the type of the fuel permeating section 7 is not particularly limited as far as it is possible for the liquid fuel to permeate into the fuel permeating section 7 by utilizing the capillary action. To be more specific, it is possible for the fuel permeating section 7 to be formed of a porous body consisting of particles or fillers, to be formed of an unwoven fabric manufactured by the paper-making method, or to be formed of a woven fabric prepared by weaving fibers. Further, it is also possible for the fuel permeating section 7 to be formed of fine clearances formed between the plates of glass or a plastic material.

The following description covers the case where the fuel permeating section 7 is formed of a porous body. The capillary force for sucking the liquid fuel into the fuel permeating section 7 includes the capillary action of the porous body itself constituting the fuel permeating section 7. Where the particular capillary force is utilized, it is possible to supply the liquid fuel smoothly in the lateral direction by utilizing the capillary action by forming a so-called open pore in which the pores of the fuel permeating section formed of a porous material are connected to each other, i.e., the open pore extending from the side surface of the fuel permeating section 7 near the liquid fuel introducing section 1 to reach at least an additional another surface, and by controlling the diameter of the open pore.

The pore diameter, etc. of the porous body used for forming the fuel permeating section 7 is not particularly limited as long as the pore is capable of sucking by capillary action the liquid fuel held on the liquid fuel introducing passageway 1. To be more specific, it is desirable for the porous body noted above to have pores having a diameter of about 0.01 to 150 μm in view of the capillary action of the liquid fuel introducing passageway 1. Also, it is desirable for the volume of the pore providing a criterion of the continuity of the pores formed in the porous body to be about 20 to 90%. Where the pore diameter is smaller than 0.01 μm, it is difficult to manufacture the fuel permeating section 7. On the other hand, where the pore diameter exceeds 150 μm, the capillary force of the pore tends to be lowered. Further, where the volume of the pore is smaller than 20%, the amount of the open pore is decreased to increase the amount of the closed pore, with the result that it is difficult to obtain a sufficient capillary force. On the other hand, where the volume of the pore noted above exceeds 90%, the amount of the open pore is certainly increased. However, the mechanical strength of the porous body is weakened to make it difficult to manufacture the fuel permeating section 7. In practice, it is desirable for the porous body forming the fuel permeating section 7 to have a pore diameter falling within a range of 0.5 to 100 μm and to have a pore volume of 30 to 75%.

It is desirable for the particular fuel cell to be operated at a temperature under which the water supervision can be performed easily in order to permit the electrolyte membrane to exhibit the proton conductivity sufficiently. It is desirable for the fuel cell to be operated under a wide temperature range of room temperature to 150° C. If the fuel cell is operated under the high temperatures of 50° C. to 150° C., the catalytic activity of the electrode can be improved to decrease the electrode over-voltage.

The present invention will now be described in more detail with reference to Examples of the present invention, which are directed to specific examples, though the following examples do not limit the scope of the present invention.

### EXAMPLE 1

50 ml of an ethanol solution having 0.5 g of trimethyl borate {B(OCH₃)₃} dissolved therein was mixed with 40 ml of an ethanol solution having 9 g of tetraethoxy silane {Si(OC₂H₅)₄} dissolved therein to carry out hydrolysis, thereby preparing a precursor solution of an oxide having a super strong acidity. The solution was prepared such that the element ratio Y/X of the boron element Y of boron oxide to the silicon element X of silicon oxide was set at 0.1. Also, the precursor solution was prepared to contain 3% of the solid component of the oxide having a super strong acidity. A glass paper having a porosity of 80% and a thickness of 50 μm was prepared as a porous membrane. The porous membrane was impregnated with the precursor solution of the oxide having a super strong acidity prepared in the previous step, followed by drying the precursor solution at 60° C. for 12 hours and subsequently baking the porous membrane at 700° C. for one hour. The impregnation, the drying and the baking operations described above were repeated a plurality of times, with the result that the loading rate of the oxide having a super strong acidity in the porous membrane was found to be 84% and the thickness of the electrolyte membrane was found to be 51 μm.

The oxide having a super strong acidity loaded in the porous membrane was found to be an oxide mixture consisting essentially of boron oxide bonded to silicon oxide and having an element ratio Y/X of the boron element Y of the boron oxide to the silicon element X of the silicon oxide of 0.1. The oxide having a super strong acidity was separated from the glass paper by pulverizing to carry out an X-ray diffraction measurement. It was confirmed from the diffraction peak that the oxide having a super strong acidity had an amorphous structure.

Incidentally, the element ratio Y/X of the oxide having a super strong acidity loaded in the porous membrane was measured as follows. Specifically, the oxide having a super strong acidity was separated from the glass paper by pulverizing. Then, a powder of the oxide having a super strong acidity thus obtained was dissolved in an acid or an alkali, and the element ratio Y/X was measured by inductively coupled plasma spectrometry (ICP).

### EXAMPLE 2

50 ml of a distilled water having 0.8 g of vanadium chloride (VCl₃) dissolved therein was mixed with 50 ml of an ethanol solution having 9 g of tetraethoxy silane {Si(OC₂H₅)₄} dissolved therein to carry out hydrolysis, thereby preparing a precursor solution of an oxide having a super strong acidity. The solution was prepared such that the element ratio Y/X of the vanadium element Y of vanadium oxide to the silicon element X of silicon oxide was set at 0.1. Also, the precursor solution was prepared to contain 3% of the solid component of the oxide having a super strong acidity.

A glass paper having a porosity of 80% and a thickness of 50 μm was prepared as a porous membrane. The porous membrane was impregnated with the precursor solution of the oxide having a super strong acidity prepared in the previous step, followed by drying the precursor solution at 60° C. for 12 hours and subsequently baking the porous membrane at 700° C. for one hour. The impregnation, the drying and the baking operations described above were repeated a plurality of times, with the result that the loading rate of the oxide having a super strong acidity in the porous membrane was found to be 85% and the thickness of the electrolyte membrane was found to be 51 μm.

The oxide having a super strong acidity loaded in the porous membrane was found to be an oxide mixture consisting essentially of vanadium oxide bonded to silicon oxide and having an element ratio Y/X of the vanadium element Y of the vanadium oxide to the silicon element X of the silicon oxide of 0.1. The oxide having a super strong acidity was separated from the glass paper by pulverizing to carry out an X-ray diffraction measurement. It was confirmed from the diffraction peak that the oxide having a super strong acidity had an amorphous structure.

Incidentally, the element ratio Y/X of the oxide having a super strong acidity loaded in the porous membrane was measured as follows. Specifically, the oxide having a super strong acidity was separated from the glass paper by pulverizing. Then, a powder of the oxide having a super strong acidity thus obtained was dissolved in an acid or an alkali, and the element ratio Y/X was measured by inductively coupled plasma spectrometry (ICP).

### EXAMPLE 3

50 ml of a distilled water having 1.3 g of chromium chloride hexahydrate {CrCl₃.6H₂O} dissolved therein was mixed with 50 ml of an ethanol solution having 9 g of tetraethoxy silane {Si(OC₂H₅)₄} dissolved therein to carry out hydrolysis, thereby preparing a precursor solution of an oxide having a super strong acidity. The solution was prepared such that the element ratio Y/X of the chromium element Y of chromium oxide to the silicon element X of silicon oxide was set at 0.1. Also, the precursor solution was prepared to contain 3% of the solid component of the oxide having a super strong acidity.

A glass paper having a porosity of 80% and a thickness of 50 μm was prepared as a porous membrane. The porous membrane was impregnated with the precursor solution of the oxide having a super strong acidity prepared in the previous step, followed by drying the precursor solution at 60° C. for 12 hours and subsequently baking the porous membrane at 700° C. for one hour. The impregnation, the drying and the baking operations described above were repeated a plurality of times, with the result that the loading rate of the oxide having a super strong acidity in the porous membrane was found to be 83% and the thickness of the electrolyte membrane was found to be 50 μm.

The oxide having a super strong acidity loaded in the porous membrane was found to be an oxide mixture consisting essentially of chromium oxide bonded to silicon oxide and having an element ratio Y/X of the chromium element Y of the chromium oxide to the silicon element X of the silicon oxide of 0.1. The oxide having a super strong acidity was separated from the glass paper by pulverizing to carry out an X-ray diffraction measurement. It was confirmed from the diffraction peak that the oxide having a super strong acidity had an amorphous structure.

Incidentally, the element ratio Y/X of the oxide having a super strong acidity loaded in the porous membrane was measured as follows. Specifically, the oxide having a super strong acidity was separated from the glass paper by pulverizing. Then, a powder of the oxide having a super strong acidity thus obtained was dissolved in an acid or an alkali, and the element ratio Y/X was measured by inductively coupled plasma spectrometry (ICP).

### EXAMPLE 4

50 ml of a 2% hydrochloric acid aqueous solution having 0.8 g of molybdic acid {H₂MoO₄} dissolved therein was mixed with 60 ml of an ethanol solution having 9 g of tetraethoxy silane {Si(OC₂H₅)₄} dissolved therein to carry out hydrolysis, thereby preparing a precursor solution of an oxide having a super strong acidity. The solution was prepared such that the element ratio Y/X of the molybdenum element Y of molybdenum oxide to the silicon element X of silicon oxide was set at 0.1. Also, the precursor solution was prepared to contain 3% of the solid component of the oxide having a super strong acidity.

A glass paper having a porosity of 80% and a thickness of 50 μm was prepared as a porous membrane. The porous membrane was impregnated with the precursor solution of the oxide having a super strong acidity prepared in the previous step, followed by drying the precursor solution at 60° C. for 12 hours and subsequently baking the porous membrane at 700° C. for one hour. The impregnation, the drying and the baking operations described above were repeated a plurality of times, with the result that the loading rate of the oxide having a super strong acidity in the porous membrane was found to be 82% and the thickness of the electrolyte membrane was found to be 51 μm.

The oxide having a super strong acidity loaded in the porous membrane was found to be an oxide mixture consisting essentially of molybdenum oxide bonded to silicon oxide and having an element ratio Y/X of the molybdenum element Y of the molybdenum oxide to the silicon element X of the silicon oxide of 0.1. The oxide having a super strong acidity was separated from the glass paper by pulverizing to carry out an X-ray diffraction measurement. It was confirmed from the diffraction peak that the oxide having a super strong acidity had an amorphous structure.

Incidentally, the element ratio Y/X of the oxide having a super strong acidity loaded in the porous membrane was measured as follows. Specifically, the oxide having a super strong acidity was separated from the glass paper by pulverizing. Then, a powder of the oxide having a super strong acidity thus obtained was dissolved in an acid or an alkali, and the element ratio Y/X was measured by inductively coupled plasma spectrometry (ICP).

### EXAMPLE 5

50 ml of an ethanol solution having 1.9 g of tungsten chloride (WCl₆) dissolved therein was mixed with 70 ml of an ethanol solution having 9 g of tetraethoxy silane {Si(OC₂H₅)₄} dissolved therein to carry out hydrolysis, thereby preparing a precursor solution of an oxide having a super strong acidity. The solution was prepared such that the element ratio Y/X of the tungsten element Y of tungsten oxide to the silicon element X of silicon oxide was set at 0.1. Also, the precursor solution was prepared to contain 3% of the solid component of the oxide having a super strong acidity.

A glass paper having a porosity of 80% and a thickness of 50 μm was prepared as a porous membrane. The porous membrane was impregnated with the precursor solution of the oxide having a super strong acidity prepared in the previous step, followed by drying the precursor solution at 60° C. for 12 hours and subsequently baking the porous membrane at 700° C. for one hour. The impregnation, the drying and the baking operations described above were repeated a plurality of times, with the result that the loading rate of the oxide having a super strong acidity in the porous membrane was found to be 84% and the thickness of the electrolyte membrane was found to be 51 μm.

The oxide having a super strong acidity loaded in the porous membrane was found to be an oxide mixture consisting essentially of tungsten oxide bonded to silicon oxide and having an element ratio Y/X of the tungsten element Y of the tungsten oxide to the silicon element X of the silicon oxide of 0.1. The oxide having a super strong acidity was separated from the glass paper by pulverizing to carry out an X-ray diffraction measurement. It was confirmed from the diffraction peak that the oxide having a super strong acidity had an amorphous structure.

Incidentally, the element ratio Y/X of the oxide having a super strong acidity loaded in the porous membrane was measured as follows. Specifically, the oxide having a super strong acidity was separated from the glass paper by pulverizing. Then, a powder of the oxide having a super strong acidity thus obtained was dissolved in an acid or an alkali, and the element ratio Y/X was measured by inductively coupled plasma spectrometry (ICP).

### EXAMPLE 6

Various operations were performed as in Example 1, except that 40 ml of the ethanol solution having 9 g of tetraethoxy silane {Si(OC₂H₅)₄} dissolved therein was replaced by 90 ml of an ethanol solution having 17 g of gallium nitrate hydrate {Ga(NO₃)₃.nH₂O} dissolved therein. The electrolyte membrane loaded with the oxide having a super strong acidity and having an element ratio Y/X of the boron element Y of boron oxide to the gallium element X of gallium oxide of 0.1 was found to have a loading rate of 82% and a thickness of 55 μm.

### EXAMPLE 7

Various operations were performed as in Example 2, except that 50 ml of the ethanol solution having 9 g of tetraethoxy silane {Si(OC₂H₅)₄} dissolved therein was replaced by 100 ml of an ethanol solution having 17 g of gallium nitrate hydrate {Ga(NO₃)₃.nH₂O} dissolved therein. The electrolyte membrane loaded with the oxide having a super strong acidity and having an element ratio Y/X of the vanadium element Y of vanadium oxide to the gallium element X of gallium oxide of 0.1 was found to have a loading rate of 83% and a thickness of 53 μm.

### EXAMPLE 8

Various operations were performed as in Example 3, except that 50 ml of the ethanol solution having 9 g of tetraethoxy silane {Si(OC₂H₅)₄} dissolved therein was replaced by 90 ml of an ethanol solution having 17 g of gallium nitrate hydrate {Ga(NO₃)₃.nH₂O} dissolved therein. The electrolyte membrane loaded with the oxide having a super strong acidity and having an element ratio Y/X of the chromium element Y of chromium oxide to the gallium element X of gallium oxide of 0.1 was found to have a loading rate of 82% and a thickness of 51 μm.

### EXAMPLE 9

Various operations were performed as in Example 4, except that 60 ml of the ethanol solution having 9 g of tetraethoxy silane {Si(OC₂H₅)₄} dissolved therein was replaced by 110 ml of an ethanol solution having 17 g of gallium nitrate hydrate {Ga(NO₃)₃.nH₂O} dissolved therein. The electrolyte membrane loaded with the oxide having a super strong acidity and having an element ratio Y/X of the molybdenum element Y of molybdenum oxide to the gallium element X of gallium oxide of 0.1 was found to have a loading rate of 81% and a thickness of 54 μm.

### EXAMPLE 10

Various operations were performed as in Example 5, except that 70 ml of the ethanol solution having 9 g of tetraethoxy silane {Si(OC₂H₅)₄} dissolved therein was replaced by 120 ml of an ethanol solution having 17 g of gallium nitrate hydrate {Ga(NO₃)₃.nH₂O} dissolved therein. The electrolyte membrane loaded with the oxide having a super strong acidity and having an element ratio Y/X of the tungsten element Y of tungsten oxide to the gallium element X of gallium oxide of 0.1 was found to have a loading rate of 85% and a thickness of 53 μm.

### EXAMPLE 11

Various operations were performed as in Example 1, except that 40 ml of the ethanol solution having 9 g of tetraethoxy silane {Si(OC₂H₅)₄} dissolved therein was replaced by 170 ml of an ethanol solution having 17 g of indium nitrate trihydrate {In(NO₃)₃.3H₂O} dissolved therein. The electrolyte membrane loaded with the oxide having a super strong acidity and having an element ratio Y/X of the boron element Y of boron oxide to the indium element X of indium oxide of 0.1 was found to have a loading rate of 83% and a thickness of 55 μm.

### EXAMPLE 12

Various operations were performed as in Example 2, except that 50 ml of the ethanol solution having 9 g of tetraethoxy silane {Si(OC₂H₅)₄} dissolved therein was replaced by 180 ml of an ethanol solution having 17 g of indium nitrate trihydrate {In(NO₃)₃.3H₂O} dissolved therein. The electrolyte membrane loaded with the oxide having a super strong acidity and having an element ratio Y/X of the vanadium element Y of vanadium oxide to the indium element X of indium oxide of 0.1 was found to have a loading rate of 82% and a thickness of 52 μm.

### EXAMPLE 13

Various operations were performed as in Example 3, except that 50 ml of the ethanol solution having 9 g of tetraethoxy silane {Si(OC₂H₅)₄} dissolved therein was replaced by 180 ml of an ethanol solution having 17 g of indium nitrate trihydrate {In(NO₃)₃.3H₂O} dissolved therein. The electrolyte membrane loaded with the oxide having a super strong acidity and having an element ratio Y/X of the chromium element Y of chromium oxide to the indium element X of indium oxide of 0.1 was found to have a loading rate of 82% and a thickness of 52 μm.

### EXAMPLE 14

Various operations were performed as in Example 4, except that 60 ml of the ethanol solution having 9 g of tetraethoxy silane {Si(OC₂H₅)₄} dissolved therein was replaced by 190 ml of an ethanol solution having 17 g of indium nitrate trihydrate {In(NO₃)₃.3H₂O} dissolved therein. The electrolyte membrane loaded with the oxide having a super strong acidity and having an element ratio Y/X of the molybdenum element Y of molybdenum oxide to the indium element X of indium oxide of 0.1 was found to have a loading rate of 84% and a thickness of 52 μm.

### EXAMPLE 15

Various operations were performed as in Example 5, except that 70 ml of the ethanol solution having 9 g of tetraethoxy silane {Si(OC₂H₅)₄} dissolved therein was replaced by 200 ml of an ethanol solution having 17 g of indium nitrate trihydrate {In(NO₃)₃.3H₂O} dissolved therein. The electrolyte membrane loaded with the oxide having a super strong acidity and having an element ratio Y/X of the tungsten element Y of tungsten oxide to the indium element X of indium oxide of 0.1 was found to have a loading rate of 82% and a thickness of 51 μm.

### EXAMPLE 16

Various operations were performed as in Example 1, except that 40 ml of the ethanol solution having 9 g of tetraethoxy silane {Si(OC₂H₅)₄} dissolved therein was replaced by 100 ml of an ethanol solution having 11 g of tetraethoxy germanium {Ge(OC₂H₅)₄} dissolved therein. The electrolyte membrane loaded with the oxide having a super strong acidity and having an element ratio Y/X of the boron element Y of boron oxide to the germanium element X of germanium oxide of 0.1 was found to have a loading rate of 81% and a thickness of 52 μm.

### EXAMPLE 17

Various operations were performed as in Example 2, except that 50 ml of the ethanol solution having 9 g of tetraethoxy silane {Si(OC₂H₅)₄} dissolved therein was replaced by 110 ml of an ethanol solution having 11 g of tetraethoxy germanium {Ge(OC₂H₅)₄} dissolved therein, and that 50 ml of the distilled water having 0.8 g of vanadium chloride (VCl₃) dissolved therein was replaced by 50 ml of an ethanol solution having 1 g of vanadium triethoxy oxide {VO(OC₂H₅)₃} dissolved therein. The electrolyte membrane loaded with the oxide having a super strong acidity and having an element ratio Y/X of the vanadium element Y of vanadium oxide to the germanium element X of germanium oxide of 0.1 was found to have a loading rate of 81% and a thickness of 51 μm.

### EXAMPLE 18

Various operations were performed as in Example 3, except that 50 ml of the ethanol solution having 9 g of tetraethoxy silane {Si(OC₂H₅)₄} dissolved therein was replaced by 110 ml of an ethanol solution having 11 g of tetraethoxy germanium {Ge(OC₂H₅)₄} dissolved therein. The electrolyte membrane loaded with the oxide having a super strong acidity and having an element ratio Y/X of the chromium element Y of chromium oxide to the germanium element X of germanium oxide of 0.1 was found to have a loading rate of 82% and a thickness of 52 μm.

### EXAMPLE 19

Various operations were performed as in Example ⁴, except that 60 ml of the ethanol solution having 9 g of tetraethoxy silane {Si(OC₂H₅)₄} dissolved therein was replaced by 120 ml of an ethanol solution having 11 g of tetraethoxy germanium {Ge(OC₂H₅)₄} dissolved therein, and that 50 ml of a 2% hydrochloric acid aqueous solution having 0.8 g of molybdic acid {H₂MoO₄} dissolved therein was replaced by 50 ml of an ethanol solution having 1.4 g of pentaethoxy molybdenum {Mo(OC₂H₅)₅} dissolved therein. The electrolyte membrane loaded with the oxide having a super strong acidity and having an element ratio Y/X of the molybdenum element Y of molybdenum oxide to the germanium element X of germanium oxide of 0.1 was found to have a loading rate of 83% and a thickness of 54 μm.

### EXAMPLE 20

Various operations were performed as in Example 5, except that 70 ml of the ethanol solution having 9 g of tetraethoxy silane {Si(OC₂H₅)₄} dissolved therein was replaced by 130 ml of an ethanol solution having 11 g of tetraethoxy germanium {Ge(OC₂H₅)₄} dissolved therein. The electrolyte membrane loaded with the oxide having a super strong acidity and having an element ratio Y/X of the tungsten element Y of tungsten oxide to the germanium element X of germanium oxide of 0.1 was found to have a loading rate of 84% and a thickness of 51 μm.

### EXAMPLE 21

Various operations were performed as in Example 1, except that 40 ml of the ethanol solution having 9 g of tetraethoxy silane {Si(OC₂H₅)₄} dissolved therein was replaced by 60 ml of an ethanol solution having 8 g of titanium chloride {TiCl₄} dissolved therein. The electrolyte membrane loaded with the oxide having a super strong acidity and having an element ratio Y/X of the boron element Y of boron oxide to the titanium element X of titanium oxide of 0.1 was found to have a loading rate of 81% and a thickness of 52 μm.

### EXAMPLE 22

Various operations were performed as in Example 2, except that 50 ml of the ethanol solution having 9 g of tetraethoxy silane {Si(OC₂H₅)₄} dissolved therein was replaced by 70 ml of an ethanol solution having 8 g of titanium chloride {TiCl₄} dissolved therein. The electrolyte membrane loaded with the oxide having a super strong acidity and having an element ratio Y/X of the vanadium element Y of vanadium oxide to the titanium element X of titanium oxide of 0.1 was found to have a loading rate of 83% and a thickness of 51 μm.

### EXAMPLE 23

Various operations were performed as in Example 3, except that 50 ml of the ethanol solution having 9 g of tetraethoxy silane {Si(OC₂H₅)₄} dissolved therein was replaced by 70 ml of an ethanol solution having 8 g of titanium chloride {TiCl₄} dissolved therein. The electrolyte membrane loaded with the oxide having a super strong acidity and having an element ratio Y/X of the chromium element Y of chromium oxide to the titanium element X of titanium oxide of 0.1 was found to have a loading rate of 80% and a thickness of 51 μm.

### EXAMPLE 24

Various operations were performed as in Example 4, except that 60 ml of the ethanol solution having 9 g of tetraethoxy silane {Si(OC₂H₅)₄} dissolved therein was replaced by 80 ml of an ethanol solution having 8 g of titanium chloride {TiCl₄} dissolved therein. The electrolyte membrane loaded with the oxide having a super strong acidity and having an element ratio Y/X of the molybdenum element Y of molybdenum oxide to the titanium element X of titanium oxide of 0.1 was found to have a loading rate of 82% and a thickness of 52 μm.

### EXAMPLE 25

Various operations were performed as in Example 5, except that 70 ml of the ethanol solution having 9 g of tetraethoxy silane {Si(OC₂H₅)₄} dissolved therein was replaced by 90 ml of an ethanol solution having 8 g of titanium chloride {TiCl₄} dissolved therein. The electrolyte membrane loaded with the oxide having a super strong acidity and having an element ratio Y/X of the tungsten element Y of tungsten oxide to the titanium element X of titanium oxide of 0.1 was found to have a loading rate of 81% and a thickness of 53 μm.

### EXAMPLE 26

Various operations were performed as in Example 1, except that 40 ml of the ethanol solution having 9 g of tetraethoxy silane {Si(OC₂H₅)₄} dissolved therein was replaced by 140 ml of an ethanol solution having 14 g of pentaethoxy niobium {Nb(OC₂H₅)₅} dissolved therein. The electrolyte membrane loaded with the oxide having a super strong acidity and having an element ratio Y/X of the boron element Y of boron oxide to the niobium element X of niobium oxide of 0.1 was found to have a loading rate of 82% and a thickness of 54 μm.

### EXAMPLE 27

Various operations were performed as in Example 2, except that 50 ml of the ethanol solution having 9 g of tetraethoxy silane {Si(OC₂H₅)₄} dissolved therein was replaced by 150 ml of an ethanol solution having 14 g of pentaethoxy niobium {Nb(OC₂H₅)₅} dissolved therein, and that 50 ml of the distilled water having 0.8 g of vanadium chloride (VCl₃) dissolved therein was replaced by 50 ml of an ethanol solution having 1 g of vanadium triethoxy oxide {VO(OC₂H₅)₃} dissolved therein. The electrolyte membrane loaded with the oxide having a super strong acidity and having an element ratio Y/X of the vanadium element Y of vanadium oxide to the niobium element X of niobium oxide of 0.1 was found to have a loading rate of 84% and a thickness of 53 μm.

### EXAMPLE 28

Various operations were performed as in Example 3, except that 50 ml of the ethanol solution having 9 g of tetraethoxy silane {Si(OC₂H₅)₄} dissolved therein was replaced by 150 ml of an ethanol solution having 14 g of pentaethoxy niobium {Nb(OC₂H₅)₅} dissolved therein. The electrolyte membrane loaded with the oxide having a super strong acidity and having an element ratio Y/X of the chromium element Y of chromium oxide to the niobium element X of niobium oxide of 0.1 was found to have a loading rate of 81% and a thickness of 51 μm.

### EXAMPLE 29

Various operations were performed as in Example 4, except that 60 ml of the ethanol solution having 9 g of tetraethoxy silane {Si(OC₂H₅)₄} dissolved therein was replaced by 160 ml of an ethanol solution having 14 g of pentaethoxy niobium {Nb(OC₂H₅)₅} dissolved therein, and that 50 ml of the 2% hydrochloric acid aqueous solution having 0.8 g of molybdic acid (H₂MoO₄) dissolved therein was replaced by 50 ml of an ethanol solution having 1.4 g of pentaethoxy molybdenum {Mo(OC₂H₅)₅} dissolved therein. The electrolyte membrane loaded with the oxide having a super strong acidity and having an element ratio Y/X of the molybdenum element Y of molybdenum oxide to the niobium element X of niobium oxide of 0.1 was found to have a loading rate of 85% and a thickness of 52 μm.

### EXAMPLE 30

Various operations were performed as in Example 5, except that 70 ml of the ethanol solution having 9 g of tetraethoxy silane {Si(OC₂H₅)₄} dissolved therein was replaced by 170 ml of an ethanol solution having 14 g of pentaethoxy niobium {Nb(OC₂H₅)₅} dissolved therein. The electrolyte membrane loaded with the oxide having a super strong acidity and having an element ratio Y/X of the tungsten element Y of tungsten oxide to the niobium element X of niobium oxide of 0.1 was found to have a loading rate of 83% and a thickness of 55 μm.

### EXAMPLE 31

Various operations were performed as in Example 1, except that 40 ml of the ethanol solution having 9 g of tetraethoxy silane {Si(OC₂H₅)₄} dissolved therein was replaced by 140 ml of an aqueous solution having 15 g of zirconium chloride oxide octahydrate ZrOCl₂.8H₂O dissolved therein. The electrolyte membrane loaded with the oxide having a super strong acidity and having an element ratio Y/X of the boron element Y of boron oxide to the zirconium element X of zirconium oxide of 0.1 was found to have a loading rate of 81% and a thickness of 51 μm.

### EXAMPLE 32

Various operations were performed as in Example 2, except that 50 ml of the ethanol solution having 9 g of tetraethoxy silane {Si(OC₂H₅)₄} dissolved therein was replaced by 150 ml of an aqueous solution having 15 g of zirconium chloride oxide octahydrate ZrOCl₂.8H₂O dissolved therein. The electrolyte membrane loaded with the oxide having a super strong acidity and having an element ratio Y/X of the vanadium element Y of vanadium oxide to the zirconium element X of zirconium oxide of 0.1 was found to have a loading rate of 84% and a thickness of 52 μm.

### EXAMPLE 33

Various operations were performed as in Example 3, except that 50 ml of the ethanol solution having 9 g of tetraethoxy silane {Si(OC₂H₅)₄} dissolved therein was replaced by 150 ml of an aqueous solution having 15 g of zirconium chloride oxide octahydrate ZrOCl₂.8H₂O dissolved therein. The electrolyte membrane loaded with the oxide having a super strong acidity and having an element ratio Y/X of the chromium element Y of chromium oxide to the zirconium element X of zirconium oxide of 0.1 was found to have a loading rate of 81% and a thickness of 51 μm.

### EXAMPLE 34

Various operations were performed as in Example 4, except that 60 ml of the ethanol solution having 9 g of tetraethoxy silane {Si(OC₂H₅)₄} dissolved therein was replaced by 160 ml of an aqueous solution having 15 g of zirconium chloride oxide octahydrate ZrOCl₂.8H₂O dissolved therein. The electrolyte membrane loaded with the oxide having a super strong acidity and having an element ratio Y/X of the molybdenum element Y of molybdenum oxide to the zirconium element X of zirconium oxide of 0.1 was found to have a loading rate of 82% and a thickness of 54 μm.

### EXAMPLE 35

Various operations were performed as in Example 5, except that 70 ml of the ethanol solution having 9 g of tetraethoxy silane {Si(OC₂H₅)₄} dissolved therein was replaced by 170 ml of an aqueous solution having 15 g of zirconium chloride oxide octahydrate ZrOCl₂.8H₂O dissolved therein. The electrolyte membrane loaded with the oxide having a super strong acidity and having an element ratio Y/X of the tungsten element Y of tungsten oxide to the zirconium element X of zirconium oxide of 0.1 was found to have a loading rate of 83% and a thickness of 53 μm.

### EXAMPLE 36

Various operations were performed as in Example 1, except that 40 ml of the ethanol solution having 9 g of tetraethoxy silane {Si(OC₂H₅)₄} dissolved therein was replaced by 280 ml of an aqueous solution having 20 g of hafnium chloride oxide octahydrate HfOCl₂.8H₂O dissolved therein. The electrolyte membrane loaded with the oxide having a super strong acidity and having an element ratio Y/X of the boron element Y of boron oxide to the hafnium element X of hafnium oxide of 0.1 was found to have a loading rate of 81% and a thickness of 52 μm.

### EXAMPLE 37

Various operations were performed as in Example 2, except that 50 ml of the ethanol solution having 9 g of tetraethoxy silane {Si(OC₂H₅)₄} dissolved therein was replaced by 290 ml of an aqueous solution having 20 g of hafnium chloride oxide octahydrate HfOCl₂.8H₂O dissolved therein. The electrolyte membrane loaded with the oxide having a super strong acidity and having an element ratio Y/X of the vanadium element Y of vanadium oxide to the hafnium element X of hafnium oxide of 0.1 was found to have a loading rate of 83% and a thickness of 51 μm.

### EXAMPLE 38

Various operations were performed as in Example 3, except that 50 ml of the ethanol solution having 9 g of tetraethoxy silane {Si(OC₂H₅)₄} dissolved therein was replaced by 290 ml of an aqueous solution having 20 g of hafnium chloride oxide octahydrate HfOCl₂.8H₂O dissolved therein. The electrolyte membrane loaded with the oxide having a super strong acidity and having an element ratio Y/X of the chromium element Y of chromium oxide to the hafnium element X of hafnium oxide of 0.1 was found to have a loading rate of 83% and a thickness of 54 μm.

### EXAMPLE 39

Various operations were performed as in Example 4, except that 60 ml of the ethanol solution having 9 g of tetraethoxy silane {Si(OC₂H₅)₄} dissolved therein was replaced by 300 ml of an aqueous solution having 20 g of hafnium chloride oxide octahydrate HfOCl₂.8H₂O dissolved therein. The electrolyte membrane loaded with the oxide having a super strong acidity and having an element ratio Y/X of the molybdenum element Y of molybdenum oxide to the hafnium element X of hafnium oxide of 0.1 was found to have a loading rate of 85% and a thickness of 52 μm.

### EXAMPLE 40

Various operations were performed as in Example 5, except that 70 ml of the ethanol solution having 9 g of tetraethoxy silane {Si(OC₂H₅)₄} dissolved therein was replaced by 310 ml of an aqueous solution having 20 g of hafnium chloride oxide octahydrate HfOCl₂.8H₂O dissolved therein. The electrolyte membrane loaded with the oxide having a super strong acidity and having an element ratio Y/X of the tungsten element Y of tungsten oxide to the hafnium element X of hafnium oxide of 0.1 was found to have a loading rate of 82% and a thickness of 53 μm.

### EXAMPLE 41

Various operations were performed as in Example 1, except that 40 ml of the ethanol solution having 9 g of tetraethoxy silane {Si(OC₂H₅)₄} dissolved therein was replaced by 210 ml of an aqueous solution having 20 g of cerium nitrate hexahydrate {Ce(NO₃)₃.6H₂O} dissolved therein. The electrolyte membrane loaded with the oxide having a super strong acidity and having an element ratio Y/X of the boron element Y of boron oxide to the cerium element X of cerium oxide of 0.1 was found to have a loading rate of 82% and a thickness of 51 μm.

### EXAMPLE 42

Various operations were performed as in Example 2, except that 50 ml of the ethanol solution having 9 g of tetraethoxy silane {Si(OC₂H₅)₄} dissolved therein was replaced by 220 ml of an aqueous solution having 20 g of cerium nitrate hexahydrate {Ce(NO₃)₃.6H₂O} dissolved therein. The electrolyte membrane loaded with the oxide having a super strong acidity and having an element ratio Y/X of the vanadium element Y of vanadium oxide to the cerium element X of cerium oxide of 0.1 was found to have a loading rate of 81% and a thickness of 54 μm.

### EXAMPLE 43

Various operations were performed as in Example 3, except that 50 ml of the ethanol solution having 9 g of tetraethoxy silane {Si(OC₂H₅)₄} dissolved therein was replaced by 220 ml of an aqueous solution having 20 g of cerium nitrate hexahydrate {Ce(NO₃)₃.6H₂O} dissolved therein. The electrolyte membrane loaded with the oxide having a super strong acidity and having an element ratio Y/X of the chromium element Y of chromium oxide to the cerium element X of cerium oxide of 0.1 was found to have a loading rate of 84% and a thickness of 52 μm.

### EXAMPLE 44

Various operations were performed as in Example 4, except that 60 ml of the ethanol solution having 9 g of tetraethoxy silane {Si(OC₂H₅)₄} dissolved therein was replaced by 230 ml of an aqueous solution having 20 g of cerium nitrate hexahydrate {Ce(NO₃)₃.6H₂O} dissolved therein. The electrolyte membrane loaded with the oxide having a super strong acidity and having an element ratio Y/X of the molybdenum element Y of molybdenum oxide to the cerium element X of cerium oxide of 0.1 was found to have a loading rate of 82% and a thickness of 52 μm.

### EXAMPLE 45

Various operations were performed as in Example 5, except that 70 ml of the ethanol solution having 9 g of tetraethoxy silane {Si(OC₂H₅)₄} dissolved therein was replaced by 240 ml of an aqueous solution having 20 g of cerium nitrate hexahydrate {Ce(NO₃)₃.6H₂O} dissolved therein. The electrolyte membrane loaded with the oxide having a super strong acidity and having an element ratio Y/X of the tungsten element Y of tungsten oxide to the cerium element X of cerium oxide of 0.1 was found to have a loading rate of 83% and a thickness of 55 μm.

### EXAMPLE 46

Various operations were performed as in Example 1, except that 40 ml of the ethanol solution having 9 g of tetraethoxy silane {Si(OC₂H₅)₄} dissolved therein was replaced by 180 ml of an aqueous solution having 16 g of tin chloride pentahydrate {SnCl₄.5H₂O} dissolved therein. The electrolyte membrane loaded with the oxide having a super strong acidity and having an element ratio Y/X of the boron element Y of boron oxide to the tin element X of tin oxide of 0.1 was found to have a loading rate of 84% and a thickness of 52 μm.

### EXAMPLE 47

Various operations were performed as in Example 2, except that 50 ml of the ethanol solution having 9 g of tetraethoxy silane {Si(OC₂H₅)₄} dissolved therein was replaced by 190 ml of an aqueous solution having 16 g of tin chloride pentahydrate (SnCl₄.5H₂O) dissolved therein. The electrolyte membrane loaded with the oxide having a super strong acidity and having an element ratio Y/X of the vanadium element Y of vanadium oxide to the tin element X of tin oxide of 0.1 was found to have a loading rate of 81% and a thickness of 55 μm.

### EXAMPLE 48

Various operations were performed as in Example 3, except that 50 ml of the ethanol solution having 9 g of tetraethoxy silane {Si(OC₂H₅)₄} dissolved therein was replaced by 180 ml of an aqueous solution having 16 g of tin chloride pentahydrate (SnCl₄.5H₂O) dissolved therein. The electrolyte membrane loaded with the oxide having a super strong acidity and having an element ratio Y/X of the chromium element Y of chromium oxide to the tin element X of tin oxide of 0.1 was found to have a loading rate of 82% and a thickness of 54 μm.

### EXAMPLE 49

Various operations were performed as in Example 4, except that 60 ml of the ethanol solution having 9 g of tetraethoxy silane {Si(OC₂H₅)₄} dissolved therein was replaced by 190 ml of an aqueous solution having 16 g of tin chloride pentahydrate (SnCl₄.5H₂O) dissolved therein. The electrolyte membrane loaded with the oxide having a super strong acidity and having an element ratio Y/X of the molybdenum element Y of molybdenum oxide to the tin element X of tin oxide of 0.1 was found to have a loading rate of 83% and a thickness of 52 μm.

### EXAMPLE 50

Various operations were performed as in Example 5, except that 70 ml of the ethanol solution having 9 g of tetraethoxy silane {Si(OC₂H₅)₄} dissolved therein was replaced by 200 ml of an aqueous solution having 16 g of tin chloride pentahydrate (SnCl₄.5H₂O) dissolved therein. The electrolyte membrane loaded with the oxide having a super strong acidity and having an element ratio Y/X of the tungsten element Y of tungsten oxide to the tin element X of tin oxide of 0.1 was found to have a loading rate of 83% and a thickness of 54 μm.

### COMPARATIVE EXAMPLE 1

Prepared was a NAFION 117 membrane manufactured by Du Pont Inc. as an electrolyte membrane.

### COMPARATIVE EXAMPLE 2

A mixed solution obtained by adding 6 g of silicon oxide (SiO₂) to 300 ml of a distilled water having 2 g of vanadium chloride (VCl₃) dissolved therein was heated to 80° C. while stirring the mixed solution to remove water at an evaporating rate of 100 ml/hour. Further, the heated mixed solution was left to stand for 12 hours within a drying vessel maintained at 100° C. to obtain a powdery material. The powdery material was pulverized within an agate mortar, followed by heating the pulverized material to 700° C. within an alumina crucible at a temperature elevation rate of 100° C./hour and subsequently maintaining the heated material at 700° C. for 4 hours to obtain silicon oxide supporting vanadium oxide. The silicon oxide supporting vanadium oxide thus obtained was found to have an element ratio Y/X of the silicon element Y of silicon oxide to the vanadium element X of vanadium oxide of 0.1 and also to have a specific surface area of 55 m²/g. An X-ray diffraction measurement was applied to the silicon oxide supporting vanadium oxide, with the result that all the diffraction peaks were found to be ascribed to silicon oxide. It was also confirmed that vanadium oxide had an amorphous structure.

One gram of the oxide having a super strong acidity powder was added to 2 g of a 5% aqueous solution of polyvinyl alcohol (PVA), and the mixture was stirred at room temperature for 10 minutes to prepare a slurry. The slurry thus prepared was put into a petri dish made of tetrafluoro ethylene-perfluoro alkoxy vinyl ether copolymer (PFA) resin. Under this condition, the solvent was dried at 60° C. and, then, at 150° C. under an air atmosphere to obtain an electrolyte membrane. The ratio S/T of the weight (S) of the proton conductive inorganic material to the total weight (T) of the membrane was found to be 0.9, the thickness of the electrolyte membrane was found to be 51 μm, and the equilibrium absorption rate of the membrane was found to be 25%.

The oxide mixture of the electrolyte membrane obtained in each of Examples 1 to 50 and Comparative Example 2 was separated by pulverizing, and found to exhibit a solid super strong acidity when examined with an acidic indicator consisting essentially of m-nitro toluene (pKa=−11.99), p-nitro fluorobenzene (pKa=−12.40), p-nitro chlorobenzene (pKa=−12.70), m-nitro chlorobenzene (pKa=−13.16), 2,4-dinitro toluene (pKa=−13.75), 2,4-dinitro fluorobenzene (pKa=−14.52), and 1,3,5-trinitro benzene (pKa=−16.04). Also, where SnO₂ or the oxide having a super strong acidity is colored, it is difficult to evaluate the solid acidity from the color change of the acidic indicator. In such a case, the solid acidity can be measured by employing a temperature programmed desorption method using ammonia (TPD). In this method, an ammonia gas is adsorbed on the solid super acid sample and the temperature of the sample is elevated to detect the desorbed amount of the ammonia and the desorbing temperature, thereby performing the desired analysis. Tables 1 to 3 show the Hammett acidity function H₀ for each of the proton conductive membranes.

Also, a liquid fuel cell was assembled as follows by using each of the electrolyte membranes for Examples 1 to 50 and Comparative Examples 1 and 2.

In the first step, an electrode containing a carbon carrier supporting 10% of Pt (catalyst amount: Pt 4 mg/cm², manufactured by E-tek) was impregnated with a 5% NAFION solution to obtain an oxidizing electrode 3. Also, an electrode containing a carbon carrier supporting 10% of Pt—Ru (catalyst amount: Pt—Ru 4 mg/cm², manufactured by E-tek) was impregnated with a 5% NAFION solution to obtain a fuel electrode 2.

A proton conductive membrane 4 was arranged between the fuel electrode 2 and the oxidizing electrode 3, and the resultant system was subjected to a hot press at 120° C. for 5 minutes under the pressure of 100 kg/cm² to obtain a membrane electrode assembly 5, thereby obtaining an electromotive section.

A porous carbon plate having an average pore size of 100 μm and a porosity of 70% was laminated as a fuel evaporating section 6 on the fuel electrode 2 included in the electromotive section 5 thus obtained. Further, a porous carbon plate having an average pore size of 5 μm and a porosity of 40% was arranged as a fuel permeating section 7 on the fuel evaporating section 6. The resultant structure was incorporated inside the space defined between a holder 10 of the oxidizing electrode equipped with the oxidizing gas supply channel 9 and a holder 11 of the fuel electrode 2 to manufacture a unit cell constructed as shown in FIG. 3. The reaction area of the unit cell was found to be 10 cm². Incidentally, the oxidizing gas supply channel 9 of the holder 10 of the oxidizing electrode was found to have a depth of 2 mm and a width of 1 mm.

A 20% methanol aqueous solution was introduced into the liquid fuel cell thus manufactured through the side surface of the fuel permeating section 7 as shown in FIG. 3. On the other hand, air of 1 atm used as the oxidizing agent gas was allowed to flow into a gas channel 9 at a flow rate of 100 ml/min, thereby performing the power generation. The carbon dioxide (CO₂) generated in accordance with the power generating reaction was released to the outside through the fuel evaporating section 6 as shown in FIG. 3. Each of Tables 1 to 3 shows the maximum power generation amount.

To be more specific, each of Tables 1 to 3 shows the methanol permeability, the membrane resistance, and the maximum power generation amount in the case of using a 20% methanol solution as a liquid fuel in respect of each of the membrane electrode assemblies. It should be noted that each of the methanol permeability and the membrane resistance is given in Tables 1 to 3 as a relative value on the basis that the value of the NAFION 117 membrane for Comparative Example 1 is set at 1.

Incidentally, for measuring the methanol permeability, a proton conductive membrane was inserted into a cell having an area of 10 cm² to divide the cell into two sections. A 10% methanol aqueous solution was put into one of the two cell sections, and pure water was put into the other cell section. A prescribed time later at room temperature, the methanol concentration in the cell section having the pure water put therein was measured by means of the gas chromatography to determine the methanol permeability. The membrane was kept dipped in water for 16 hours and, then, water was removed from the membrane to measure the methanol permeability.

Also, the electric resistance of the membrane was measured by a four terminal DC method. To be more specific, a proton conductive membrane was inserted into a cell having an area of 10 cm² to divide the cell into two sections. A 10% sulfuric acid aqueous solution was put into each of the two divided cell sections, and a DC current was circulated within the cell at room temperature to measure the voltage drop caused by the presence or absence of the proton conductive membrane, thereby determining the membrane resistance.

TABLE 1

| | | Element | Element | Acid | Relative | Relative | Maximum power generation amount |
|---|---|---|---|---|---|---|---|
| | Oxide B, | X-containing | ratio | function | methanol | membrane | during use of 20% methanol |
| | element Y | oxide A | (Y/X) | H₀ | permeability | resistance | aqueous solution (mW/cm²) |
| Example 1 | B | SiO₂ | 0.1 | −11.99 | 0.501 | 0.611 | 25.5 |
| Example 2 | V | SiO₂ | 0.1 | −11.99 | 0.492 | 0.590 | 26.2 |
| Example 3 | Cr | SiO₂ | 0.1 | −11.99 | 0.482 | 0.578 | 26.8 |
| Example 4 | Mo | SiO₂ | 0.1 | −12.40 | 0.446 | 0.534 | 29.7 |
| Example 5 | W | SiO₂ | 0.1 | −12.40 | 0.433 | 0.523 | 30.4 |
| Example 6 | B | Ga₂O₃ | 0.1 | −11.99 | 0.473 | 0.567 | 27.6 |
| Example 7 | V | Ga₂O₃ | 0.1 | −11.99 | 0.464 | 0.553 | 28.2 |
| Example 8 | Cr | Ga₂O₃ | 0.1 | −11.99 | 0.456 | 0.545 | 29.4 |
| Example 9 | Mo | Ga₂O₃ | 0.1 | −12.40 | 0.426 | 0.512 | 31.1 |
| Example 10 | W | Ga₂O₃ | 0.1 | −12.40 | 0.419 | 0.501 | 31.8 |
| Example 11 | B | In₂O₃ | 0.1 | −12.40 | 0.410 | 0.487 | 32.5 |
| Example 12 | V | In₂O₃ | 0.1 | −12.40 | 0.400 | 0.478 | 33.3 |
| Example 13 | Cr | In₂O₃ | 0.1 | −12.40 | 0.391 | 0.465 | 33.9 |
| Example 14 | Mo | In₂O₃ | 0.1 | −12.70 | 0.383 | 0.457 | 34.6 |
| Example 15 | W | In₂O₃ | 0.1 | −12.70 | 0.374 | 0.446 | 35.4 |
| Example 16 | B | GeO₂ | 0.1 | −12.70 | 0.366 | 0.433 | 36.2 |
| Example 17 | V | GeO₂ | 0.1 | −12.70 | 0.357 | 0.424 | 36.7 |
| Example 18 | Cr | GeO₂ | 0.1 | −12.70 | 0.347 | 0.415 | 37.4 |
| Example 19 | Mo | GeO₂ | 0.1 | −13.16 | 0.311 | 0.369 | 40.2 |
| Example 20 | W | GeO₂ | 0.1 | −13.16 | 0.302 | 0.358 | 40.9 |

TABLE 2

| | | Element | Element | Acid | Relative | Relative | Maximum power generation amount |
|---|---|---|---|---|---|---|---|
| | Oxide B, | X-containing | ratio | function | methanol | membrane | during use of 20% methanol |
| | element Y | oxide A | (Y/X) | H₀ | permeability | resistance | aqueous solution (mW/cm²) |
| Example 21 | B | TiO₂ | 0.1 | −12.70 | 0.340 | 0.402 | 38.1 |
| Example 22 | V | TiO₂ | 0.1 | −12.70 | 0.329 | 0.391 | 38.7 |
| Example 23 | Cr | TiO₂ | 0.1 | −12.70 | 0.320 | 0.382 | 39.4 |
| Example 24 | Mo | TiO₂ | 0.1 | −13.16 | 0.295 | 0.345 | 41.5 |
| Example 25 | W | TiO₂ | 0.1 | −13.16 | 0.286 | 0.336 | 42.3 |
| Example 26 | B | Nb₂O₃ | 0.1 | −13.16 | 0.275 | 0.322 | 43.0 |
| Example 27 | V | Nb₂O₃ | 0.1 | −13.16 | 0.266 | 0.317 | 43.8 |
| Example 28 | Cr | Nb₂O₃ | 0.1 | −13.16 | 0.255 | 0.304 | 44.4 |
| Example 29 | Mo | Nb₂O₃ | 0.1 | −13.75 | 0.246 | 0.292 | 45.0 |
| Example 30 | W | Nb₂O₃ | 0.1 | −13.75 | 0.239 | 0.280 | 45.8 |
| Example 31 | B | ZrO₂ | 0.1 | −13.75 | 0.230 | 0.271 | 46.2 |
| Example 32 | V | ZrO₂ | 0.1 | −13.75 | 0.224 | 0.259 | 47.2 |
| Example 33 | Cr | ZrO₂ | 0.1 | −13.75 | 0.213 | 0.247 | 47.8 |
| Example 34 | Mo | ZrO₂ | 0.1 | −14.52 | 0.176 | 0.204 | 50.7 |
| Example 35 | W | ZrO₂ | 0.1 | −14.52 | 0.167 | 0.189 | 51.2 |
| Example 36 | B | HfO₂ | 0.1 | −13.75 | 0.202 | 0.237 | 48.5 |
| Example 37 | V | HfO₂ | 0.1 | −13.75 | 0.192 | 0.227 | 49.2 |
| Example 38 | Cr | HfO₂ | 0.1 | −13.75 | 0.185 | 0.215 | 50.1 |
| Example 39 | Mo | HfO₂ | 0.1 | −14.52 | 0.155 | 0.180 | 52.1 |
| Example 40 | W | HfO₂ | 0.1 | −14.52 | 0.147 | 0.171 | 52.5 |

TABLE 3

| | | Element | Element | Acid | Relative | Relative | Maximum power generation amount |
|---|---|---|---|---|---|---|---|
| | Oxide B, | X-containing | ratio | function | methanol | membrane | during use of 20% methanol |
| | element Y | oxide A | (Y/X) | H₀ | permeability | resistance | aqueous solution (mW/cm²) |
| Example 41 | B | CeO₂ | 0.1 | −14.52 | 0.141 | 0.165 | 53.4 |
| Example 42 | V | CeO₂ | 0.1 | −14.52 | 0.132 | 0.149 | 54.3 |
| Example 43 | Cr | CeO₂ | 0.1 | −14.52 | 0.123 | 0.135 | 54.9 |
| Example 44 | Mo | CeO₂ | 0.1 | −15.00 | 0.113 | 0.127 | 55.6 |
| Example 45 | W | CeO₂ | 0.1 | −15.00 | 0.103 | 0.116 | 56.1 |
| Example 46 | B | SnO₂ | 0.1 | −15.00 | 0.095 | 0.104 | 57.2 |
| Example 47 | V | SnO₂ | 0.1 | −15.00 | 0.085 | 0.094 | 57.7 |
| Example 48 | Cr | SnO₂ | 0.1 | −15.00 | 0.076 | 0.083 | 58.0 |
| Example 49 | Mo | SnO₂ | 0.1 | −16.04 | 0.068 | 0.070 | 59.1 |
| Example 50 | W | SnO₂ | 0.1 | −16.04 | 0.058 | 0.061 | 59.5 |
| Comparative | — | — | — | — | 1.0 | 1.0 | 2.0 |
| Example 1 | | | | | | | |
| Comparative | V | SiO₂ | 0.1 | −11.99 | 0.8 | 0.9 | 15 |
| Example 2 | | | | | | | |

As apparent from Tables 1 to 3, the electrolyte membrane prepared by loading the oxide having a super strong acidity for each of Examples 1 to 50 in a porous membrane was found to be much lower in the membrane resistance and the methanol permeability than the electrode membrane provided by a NAFION 117 membrane for Comparative Example 1.

As apparent from Comparative Example 1 shown in Table 3, the fuel cell comprising a NAFION 117 membrane as an electrolyte membrane was found to be high in each of the methanol permeability and the membrane resistance and, thus, the output was affected. Specifically, in the case of using a 20% methanol solution as a liquid fuel, the maximum power generation amount was only 2.0 mW/cm². Also, as apparent from Comparative Example 2, in the case of using a membrane prepared by binding particles of oxide having a super strong acidity with PVA used as a polymer binder without using a porous membrane, the permeability of methanol was found to be large because of the methanol absorption that is considered to be caused by the presence of PVA. Further, the membrane resistance is large, which is considered to be caused by the situation that the proton conduction was inhibited by PVA. On the other hand, the fuel cell equipped with the electrolyte membrane prepared by loading the oxide having a super strong acidity obtained in each of Examples 1 to 50 in a porous membrane was low in either of the methanol permeability and the membrane resistance, with the result that a satisfactory power generation was obtained in the case of using a 20% methanol solution as the fuel. Particularly, the fuel cell for each of Examples 46 to 50, which contained tin oxide, exhibited a large power generation amount. The largest power generation amount was obtained in the case of using an electrolyte membrane containing tungsten oxide as in Example 50.

The stability with time of the cell performance was observed by using a unit cell comprising an electrolyte membrane prepared by loading the oxide having a super strong acidity for each of Examples 1 to 50 in a porous membrane. In this test, a 20% methanol aqueous solution was used as the fuel, and air was supplied to the unit cell as the oxidizing agent. The both surfaces of the unit cell were heated to 40° C., and a current of 10 mA/cm² was outputted for measuring the stability with time of the cell performance. The output was found to be stable even several hours later. A similar measurement was performed at 150° C., with the result that the output was found to be stable even several hours later.

The stability with time of the cell performance was also observed in respect of the fuel cell comprising a NAFION 117 membrane (Comparative Example 1) as the electrolyte membrane. In this test, a 20% methanol aqueous solution was used as the fuel, and air was supplied to the fuel cell as the oxidizing agent. The both surfaces of the unit cell were heated to 40° C., and a current of 10 mA/cm² was outputted for measuring the stability with time of the cell performance. It was impossible to obtain an output only several minutes later. A similar measurement was performed at 150° C., with the result that the electrolyte membrane was dried, and thus, it was impossible to obtain an output because it was impossible to control the humidification strictly.

### EXAMPLE 51

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 30 ml of another aqueous solution having 1.2 g of magnesium chloride hexahydrate (MgCl₂.6H₂O) dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 81% and a thickness of 52 μm. The oxide mixture was found to contain 10 mol % of magnesium element Z on the basis that the total molar amount of the elements X, Y, Z was set at 100 mol %.

### EXAMPLE 52

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 30 ml of another aqueous solution having 1.2 g of calcium chloride hexahydrate (CaCl₂.6H₂O) dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 83% and a thickness of 54 μm. The oxide mixture was found to contain 10 mol % of calcium element Z on the basis that the total molar amount of the elements X, Y, Z was set at 100 mol %.

### EXAMPLE 53

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 40 ml of another aqueous solution having 1.5 g of strontium chloride hexahydrate (SrCl₂.6H₂O) dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 81% and a thickness of 56 μm. The oxide mixture was found to contain 10 mol % of strontium element Z on the basis that the total molar amount of the elements X, Y, Z was set at 100 mol %.

### EXAMPLE 54

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 40 ml of another aqueous solution having 1.4 g of barium chloride dihydrate (BaCl₂.2H₂O) dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 82% and a thickness of 55 μm. The oxide mixture was found to contain 10 mol % of barium element Z on the basis that the total molar amount of the elements X, Y, Z was set at 100 mol %.

### EXAMPLE 55

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 30 ml of another aqueous solution having 2.5 g of scandium nitrate tetrahydrate (Sc(NO₃)₃.4H₂O) dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 83% and a thickness of 51 μm. The oxide mixture was found to contain 10 mol % of scandium element Z on the basis that the total molar amount of the elements X, Y, Z was set at 100 mol %.

### EXAMPLE 56

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 40 ml of another aqueous solution having 2.8 g of yttrium acetate tetrahydrate {Y(CH₃COO)₃.4H₂O} dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 82% and a thickness of 55 μm. The oxide mixture was found to contain 14 mol % of yttrium element Z on the basis that the total molar amount of the elements X, Y, Z was set at 100 mol %.

### EXAMPLE 57

Various operations were performed as in Example 4, except that 60 ml of the ethanol solution having 9 g of tetraethoxy silane {Si(OC₂H₅)₄} dissolved therein was replaced by 130 ml of an aqueous solution having 15 g of zirconium chloride oxide octahydrate (ZrOCl₂.8H₂O) dissolved therein and 50 ml of another aqueous solution having 3.6 g of lanthanum nitrate hexahydrate (La(NO₃)₃.6H₂O) dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the zirconium element X of zirconium oxide of 0.1 was found to have a loading rate of 82% and a thickness of 55 μm. The oxide mixture was found to contain 14 mol % of lanthanum element Z on the basis that the total molar amount of the elements X, Y, Z was set at 100 mol %.

### EXAMPLE 58

Various operations were performed as in Example 4, except that 60 ml of the ethanol solution having 9 g of tetraethoxy silane {Si(OC₂H₅)₄} dissolved therein was replaced by 220 ml of an aqueous solution having 20 g of cerium nitrate hexahydrate {Ce(NO₃)₃.6H₂O} dissolved therein and 60 ml of another aqueous solution having 4.1 g of samarium acetate tetrahydrate {Sm(CH₃COO)₃.4H₂O} dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the cerium element X of cerium oxide of 0.1 was found to have a loading rate of 82% and a thickness of 53 μm. The oxide mixture was found to contain 17 mol % of samarium element Z on the basis that the total molar amount of the elements X, Y, Z was set at 100 mol %.

### EXAMPLE 59

Various operations were performed as in Example 4, except that 60 ml of the ethanol solution having 9 g of tetraethoxy silane {Si(OC₂H₅)₄} dissolved therein was replaced by 220 ml of an aqueous solution having 20 g of cerium nitrate hexahydrate {Ce(NO₃)₃.6H₂O} dissolved therein and 60 ml of another aqueous solution having 4.7 g of gadolinium acetate pentahydrate {Gd(NO₃)₃.5H₂O} dissolved therein, and that the baking temperature of the electrolyte membrane was changed from 700° C. (Example 4) to 900° C. The electrolyte membrane loaded with the oxide having a super strong acidity and having an element ratio Y/X of the molybdenum element Y of molybdenum oxide to the cerium element X of cerium oxide of 0.1 was found to have a loading rate of 83% and a thickness of 55 μm. The oxide mixture was found to contain 17 mol % of gadolinium element Z on the basis that the total molar amount of the elements X, Y, Z was set at 100 mol %.

### EXAMPLE 60

Various operations were performed as in Example 34, except that the baking temperature of the electrolyte membrane was changed from 700° C. (Example 34) to 900° C. The electrolyte membrane loaded with the oxide having a super strong acidity and having an element ratio Y/X of the molybdenum element Y of molybdenum oxide to the zirconium element X of zirconium oxide of 0.08 was found to have a loading rate of 81% and a thickness of 51 μm.

### EXAMPLE 61

Various operations were performed as in Example 44, except that the baking temperature of the electrolyte membrane was changed from 700° C. (Example 44) to 900° C. The electrolyte membrane loaded with the oxide having a super strong acidity and having an element ratio Y/X of the molybdenum element Y of molybdenum oxide to the zirconium element X of zirconium oxide of 0.08 was found to have a loading rate of 81% and a thickness of 52 μm.

A liquid fuel cell was manufactured as in Example 1 by using the electrolyte membrane obtained in each of Examples 51 to 61.

The methanol permeability, the membrane resistance and the maximum power generation in the case of using a 20% methanol solution as a liquid fuel were measured as above for the fuel cell for each of Examples 51 to 61. Table 4 shows the experimental data.

TABLE 4

| | | | | | | | | | Maximum power |
|---|---|---|---|---|---|---|---|---|---|
| | | | Element | | | | | | generation amount |
| | | Element | Z-containing | Element | Element | Acid | Relative | Relative | during use of 20% |
| | Oxide B, | Y-containing | oxide C | ratio | ratio | function | methanol | membrane | methanol aqueous |
| | element X | oxide A | additive | (X/Y) | (Z/X + Y + Z) | H₀ | permeability | resistance | solution (mW/cm²) |
| Example 51 | Mo | ZrO₂ | MgO | 0.1 | 0.1 | −13.75 | 0.181 | 0.200 | 60.1 |
| Example 52 | Mo | ZrO₂ | CaO | 0.1 | 0.1 | −13.75 | 0.179 | 0.201 | 60.0 |
| Example 53 | Mo | ZrO₂ | SrO | 0.1 | 0.1 | −13.75 | 0.177 | 0.205 | 59.8 |
| Example 54 | Mo | ZrO₂ | BaO | 0.1 | 0.1 | −13.75 | 0.179 | 0.203 | 60.2 |
| Example 55 | Mo | ZrO₂ | Sc₂O₃ | 0.1 | 0.14 | −13.16 | 0.180 | 0.204 | 59.9 |
| Example 56 | Mo | ZrO₂ | Y₂O₃ | 0.1 | 0.14 | −13.16 | 0.179 | 0.206 | 60.3 |
| Example 57 | Mo | ZrO₂ | La₂O₃ | 0.1 | 0.14 | −13.16 | 0.177 | 0.203 | 59.7 |
| Example 58 | Mo | CeO₂ | Sm₂O₃ | 0.1 | 0.17 | −13.75 | 0.118 | 0.129 | 65.3 |
| Example 59 | Mo | CeO₂ | Gd₂O₃ | 0.1 | 0.17 | −13.75 | 0.116 | 0.130 | 65.4 |
| Example 60 | Mo | ZrO₂ | — | 0.08 | — | −14.52 | 0.176 | 0.255 | 45.2 |
| Example 61 | Mo | CeO₂ | — | 0.08 | — | −15.00 | 0.113 | 0.177 | 50.3 |

The acidity of the oxide having a super strong acidity was lowered by the addition of the basic oxide in Examples 51 to 59. However, it was possible to suppress the decrease of the proton conductive sites and to suppress the change in volume caused by the sublimation of molybdenum oxide in these Examples, though the mechanism has not yet been clarified. In addition, the membrane resistance and the methanol permeability were lowered, with the result that the power generation amount was also increased.

On the other hand, the amounts of the starting materials were charged to permit the element ratio X/Y to be 0.1 in each of Examples 60 and 61. However, molybdenum oxide was sublimed by the baking at 900° C. to change the element ratio X/Y to 0.08. Since the proton conductive sites of the electrolyte membrane were decreased, the power generation amount for each of Examples 60 and 61 was considered to be decreased, compared with the fuel cell for each of Examples 51 to 59.

### EXAMPLE 62

Various operations were performed as in Example 2, except that the baking temperature was changed from 700° C. (1 hour) to 300° C. (1 hour). The electrolyte membrane loaded with the oxide having a super strong acidity and having an element ratio Y/X of the vanadium element Y of vanadium oxide to the silicon element X of silicon oxide of 0.1 was found to have a loading rate of 85% and a thickness of 51 μm.

### EXAMPLE 63

Various operations were performed as in Example 2, except that the porous membrane was changed from a glass paper having a porosity of 80% and a thickness of 50 μm to a polyimide (PI) film having a porosity of 80% and a thickness of 50 μm, and that the baking temperature was changed from 700° C. (1 hour) to 300° C. (1 hour). The electrolyte membrane loaded with the oxide having a super strong acidity and having an element ratio Y/X of the vanadium element Y of vanadium oxide to the silicon element X of silicon oxide of 0.1 was found to have a loading rate of 83% and a thickness of 51 μm.

### EXAMPLE 64

Various operations were performed as in Example 2, except that the porous membrane was changed from a glass paper having a porosity of 80% and a thickness of 50 μm to a polytetrafluoro ethylene (PTFE) film having a porosity of 80% and a thickness of 50 μm, and that the baking temperature was changed from 700° C. (1 hour) to 300° C. (1 hour). The electrolyte membrane loaded with the oxide having a super strong acidity and having an element ratio Y/X of the vanadium element Y of vanadium oxide to the silicon element X of silicon oxide of 0.1 was found to have a loading rate of 83% and a thickness of 53 μm.

A liquid fuel cell was manufactured as in Example 1 by using the electrolyte membrane obtained in each of Examples 62 to 64.

The methanol permeability, the membrane resistance and the maximum power generation amount in the case of using a 20% methanol solution as a liquid fuel were measured as described previously for the fuel cell for each of Examples 62 to 64. Table 5 shows the experimental data. Incidentally, the experimental data for Example 2 described previously are also shown in Table 5.

TABLE 5

| | | Element | Element | Heat treating | Material | Relative | Relative | Maximum power generation |
|---|---|---|---|---|---|---|---|---|
| | Oxide B, | X-containing | ratio | temperature | of porous | methanol | membrane | amount during use of 20% |
| | element X | oxide A | (X/Y) | (° C.) | membrane | permeability | resistance | methanol aqueous solution |
| Example 2 | V | SiO₂ | 0.1 | 700 | glass | 0.492 | 0.590 | 26.2 |
| Example 62 | V | SiO₂ | 0.1 | 300 | glass | 0.501 | 0.603 | 23.1 |
| Example 63 | V | SiO₂ | 0.1 | 300 | PI | 0.452 | 0.599 | 29.3 |
| Example 64 | V | SiO₂ | 0.1 | 300 | PTFE | 0.409 | 0.601 | 32.2 |

As apparent from Table 5, the resistance of the electrolyte membrane of the fuel cell for Example 62, in which the heat treatment was carried out at 300° C., was found to be higher than that for the membrane for Example 2 in which the baking treatment was carried out at 700° C. Also, the output of the fuel cell for Example 62 was lower than that for Example 2. It is considered reasonable to understand that the vanadium oxide and the silicon oxide were not sufficiently coupled in Example 62 in which the heat treatment was carried out at 300° C. to increase the cell resistance and to lower the output as pointed out above. On the other hand, in the case where the porous membrane was changed from the glass sheet to a polyimide (PI) film or a polytetrafluoro ethylene (PTFE) film as in Example 63 or 64, an appreciable difference in the cell resistance from Example 62 was not recognized. However, the water repellency of the base material was found to greatly affect the fuel cell operation such that the methanol permeability was rendered lower than that for Example 62. As a result, the power generation output was increased.

### EXAMPLE 65

Various operations were performed as in Example 2, except that the loading rate of the oxide having a super strong acidity in the porous membrane was changed from 85% to 98%. The electrolyte membrane loaded with the oxide having a super strong acidity and having an element ratio Y/X of the vanadium element Y of vanadium oxide to the silicon element X of silicon oxide of 0.1 was found to have a thickness of 53 μm.

### EXAMPLE 66

Various operations were performed as in Example 2, except that the loading rate of the oxide having a super strong acidity in the porous membrane was changed from 85% to 80%. The electrolyte membrane loaded with the oxide having a super strong acidity and having an element ratio Y/X of the vanadium element Y of vanadium oxide to the silicon element X of silicon oxide of 0.1 was found to have a thickness of 50 μm.

A liquid fuel cell was manufactured as in Example 1 by using the electrolyte membrane obtained in each of Examples 65 and 66.

The methanol permeability, the membrane resistance and the maximum power generation amount in the case of using a 20% methanol solution as a liquid fuel were measured as described previously for the fuel cell for each of Examples 65 and 66. Table 6 shows the experimental data. Incidentally, the experimental data for Example 2 described previously are also shown in Table 6.

TABLE 6

| | | Element | Element | Loading | Relative | Relative | Maximum power generation |
|---|---|---|---|---|---|---|---|
| | Oxide B, | X-containing | ratio | rate | methanol | membrane | amount during use of 20% |
| | element X | oxide A | (X/Y) | (%) | permeability | resistance | methanol aqueous solution |
| Example 2 | V | SiO₂ | 0.1 | 85 | 0.492 | 0.590 | 26.2 |
| Example 65 | V | SiO₂ | 0.1 | 98 | 0.268 | 0.391 | 34.3 |
| Example 66 | V | SiO₂ | 0.1 | 80 | 0.520 | 0.631 | 24.6 |

As apparent from Table 6, the electrolyte membrane of the fuel cell for Example 65, which involved the highest loading rate of the oxide having a super strong acidity in the porous membrane, i.e., the loading rate of 98%, was found to be low in the methanol permeability because the porous membrane used in the electrolyte membrane for Example 65 exhibits a high shielding performance of methanol. Also, since the oxide having a super strong acidity exhibits a high continuity, the membrane resistance was low in the fuel cell for Example 65 to permit the fuel cell to exhibit a large power generation amount.

### EXAMPLE 67

Various operations were performed as in Example 2, except that the porosity of the porous membrane was changed from 80% to 50%. The electrolyte membrane loaded with the oxide having a super strong acidity and having an element ratio Y/X of the vanadium element Y of vanadium oxide to the silicon element X of silicon oxide of 0.1 was found to have a loading rate of 85% and a thickness of 51 μm.

### EXAMPLE 68

Various operations were performed as in Example 2, except that the thickness of the porous membrane was changed from 50 μm to 20 μm. The electrolyte membrane loaded with the oxide having a super strong acidity and having an element ratio Y/X of the vanadium element Y of vanadium oxide to the silicon element X of silicon oxide of 0.1 was found to have a loading rate of 85% and a thickness of 22 μm.

A liquid fuel cell was manufactured as in Example 1 by using the electrolyte membrane obtained in each of Examples 67 and 68.

The methanol permeability, the cell resistance and the maximum power generation amount were measured as described previously for the fuel cell for each of Examples 67 and 68. Table 7 shows the experimental data. Incidentally, the experimental data for Example 2 described previously are also shown in Table 7.

TABLE 7

| | | | | | | | | | Maximum power |
|---|---|---|---|---|---|---|---|---|---|
| | | | | | | | | | generation amount |
| | | Element | Element | | Thickness of | | Relative | Relative | during use of 20% |
| | Oxide B, | X-containing | ratio | Porosity | porous | Loading | methanol | membrane | methanol aqueous |
| | element X | oxide A | (X/Y) | (%) | membrane (μm) | rate (%) | permeability | resistance | solution (mW/cm²) |
| Example 2 | V | SiO₂ | 0.1 | 80 | 50 | 85 | 0.492 | 0.590 | 26.2 |
| Example 67 | V | SiO₂ | 0.1 | 50 | 50 | 85 | 0.504 | 0.921 | 18.9 |
| Example 68 | V | SiO₂ | 0.1 | 80 | 20 | 85 | 1.100 | 0.344 | 22.3 |

As apparent from Table 7, the amount of the oxide having a super strong acidity contained in the electrolyte membrane for Example 67, in which the porosity of the porous membrane was changed from 80% to 50%, was found to be smaller than that for Example 2. Since the conducting field of protons is small, the membrane resistance for Example 67 was higher than that for Example 2. Also, the maximum power generation amount of the fuel cell for Example 67 was found to be smaller than that of the fuel cell for Example 2. On the other hand, the membrane resistance was found to be low in the electrolyte membrane for Example 68, in which the thickness of the porous membrane was decreased from 50 μm to 20 μm. However, since the methanol permeability through the electrolyte membrane for Example 68 was increased, the maximum power generation amount of the fuel cell for Example 68 was found to be smaller than that for Example 2.

### EXAMPLE 69

A mixed solution obtained by adding 6 g of silicon oxide (SiO₂) to 300 ml of a distilled water having 2 g of vanadium chloride (VCl₃) dissolved therein was heated to 80° C. while stirring the mixed solution to remove water at an evaporating rate of 100 ml/hour. Further, the heated mixed solution was left to stand for 12 hours within a drying vessel maintained at 100° C. to obtain a powdery material. The powdery material was pulverized within an agate mortar, followed by heating the pulverized material to 700° C. within an alumina crucible at a temperature elevation rate of 100° C./hour and subsequently maintaining the heated material at 700° C. for 4 hours to obtain silicon oxide supporting vanadium oxide having an element ratio X/Y of the vanadium element X of vanadium oxide to the silicon element Y of silicon oxide of 0.1 and also having a specific surface area of 53 m²/g. An X-ray diffraction measurement was applied to the silicon oxide supporting vanadium oxide, with the result that all the diffraction peaks were found to be ascribed to silicon oxide. It was also confirmed that vanadium oxide had an amorphous structure.

Mixed were 0.5 g of a carbon powder supporting a 10% Pt, 0.15 g of the oxide having a super strong acidity powder prepared in the previous step, 2 g of a 5% PVA aqueous solution, 2.5 g of ethanol, and 2.5 g of water. The mixture was transferred together with zirconia balls into a closed vessel and mixed for 6 hours in a desk top ball mill to prepare a cathode catalyst slurry. A carbon paper was coated with the slurry and dried at 60° C. for one hour to obtain an electrode. Further, the electrode was baked at 150° C. for 10 minutes under a nitrogen gas stream to obtain a cathode. The cathode thus obtained was found to include a catalyst layer having a thickness of 50 μm and also having 4 mg/cm² of the Pt catalyst, and was also found to contain the oxide having a super strong acidity in an amount of 21% based on the total weight of the catalyst layer.

Also mixed were 0.5 g of a carbon powder supporting a 10% Pt—Ru, 0.15 g of the oxide having a super strong acidity powder prepared in the previous step, 2 g of a 5% PVA aqueous solution, 2.5 g of ethanol, and 2.5 g of water. The mixture was transferred together with zirconia balls into a closed vessel and mixed for 6 hours in a desk top ball mill to prepare an anode catalyst slurry. A carbon paper was coated with the slurry and dried at 60° C. for one hour to obtain an electrode. Further, the electrode was baked at 150° C. for 10 minutes under a nitrogen gas stream to obtain an anode. The anode thus obtained was found to include a catalyst layer having a thickness of 52 μm and also having 4 mg/cm² of the Pt—Ru catalyst, and was also found to contain the oxide having a super strong acidity in an amount of 20% based on the total weight of the catalyst layer.

A fuel cell was manufactured as in Example 1, except that used was the proton conductive membrane obtained in Example 2 and that also used were the fuel electrode and the oxidizing electrode obtained in Example 69.

The cell resistance and the maximum power generation amount of the fuel cell for Example 69 were measured, with the result as shown in Table 8. Incidentally, the experimental data for Example 2 and Comparative Example 1 are also shown in Table 8.

TABLE 8

| | | | | Cell | Maximum power generation |
|---|---|---|---|---|---|
| | | Electrolyte | Oxidizing | resistance | amount during use of 20% |
| | Fuel electrode | membrane | electrode | (mΩ) | methanol aqueous solution |
| Example 2 | Polymer containing | Proton conductive | Polymer containing | 15 | 26.2 |
| | perfluoro | inorganic oxide | perfluoro | | |
| | sulfonic acid | | sulfonic acid | | |
| Example 69 | Proton conductive | Proton conductive | Proton conductive | 8 | 47.5 |
| | inorganic oxide | inorganic oxide | inorganic oxide | | |
| Comparative | Polymer containing | Polymer containing | Polymer containing | 30 | 2.0 |
| Example 1 | perfluoro | perfluoro | perfluoro | | |
| | sulfonic acid | sulfonic acid | sulfonic acid | | |

In the membrane electrode assembly obtained in each of Examples 2 and 69, the proton conductor used in at least the electrolyte membrane exhibited a low resistance, leading to a low cell resistance, with the result that the membrane electrode assembly noted above exhibited output characteristics higher than those of the membrane electrode assembly obtained in Comparative Example 1, as apparent from Table 8. It should be noted that the fuel cell for Example 69 in which the oxide particles having a super strong acidity were used for preparing the electrode exhibited the highest output.

As described above in detail, the present embodiment makes it possible to provide a small fuel cell having a high performance and capable of producing a stable output. Naturally, the present embodiment produces an amazing industrial value.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electrolyte membrane comprising:
a porous membrane; and
a proton conductive inorganic material loaded in the porous membrane, having a super strong acidity, and containing a first oxide and a second oxide bonded to the first oxide, the first oxide containing an element X formed of at least one element selected from the group consisting of Ti, Zr, Hf, Nb, Al, Ga, In, Si, Ge, Sn and Ce, and the second oxide containing an element Y formed of at least one element selected from the group consisting of V, Cr, Mo, W and B.

2. The electrolyte membrane according to claim 1, wherein the proton conductive inorganic material further contain an element Z formed of at least one element selected from the group consisting of Y, Sc, La, Sm, Gd, Mg, Ca, Sr and Ba.

3. The electrolyte membrane according to claim 2, wherein an amount of the element Z falls within a range of 0.01 to 40 mol % on the basis that a total molar amount of the elements X, Y and Z is set at 100 mol %.

4. The electrolyte membrane according to claim 1, wherein a loading rate of the proton conductive inorganic material falls within a range of 80% to 98% of a porosity of the porous membrane.

5. The electrolyte membrane according to claim 1, wherein the electrolyte membrane is obtained by impregnating the porous membrane with a precursor solution containing the element X and the element Y, followed by applying a heat treatment to the porous membrane impregnated with the precursor solution at the temperature falling within a range of 200° C. to 1,000° C.

6. The electrolyte membrane according to claim 1, wherein the proton conductive inorganic material has a solid super strong acidity in which a Hammett acidity function H₀ satisfies −20.00≦H₀<−11.93.

7. A membrane electrode assembly comprising:
a fuel electrode;
an oxidizing electrode; and
an electrolyte membrane arranged between the fuel electrode and the oxidizing electrode and including a porous membrane and a proton conductive inorganic material which is loaded in the porous membrane, has a super strong acidity, and contains a first oxide and a second oxide bonded to the first oxide, the first oxide containing an element X formed of at least one element selected from the group consisting of Ti, Zr, Hf, Nb, Al, Ga, In, Si, Ge, Sn and Ce, and the second oxide containing an element Y formed of at least one element selected from the group consisting of V, Cr, Mo, W and B.

8. The membrane electrode assembly according to claim 7, wherein the proton conductive inorganic material further contain an element Z formed of at least one element selected from the group consisting of Y, Sc, La, Sm, Gd, Mg, Ca, Sr and Ba.

9. The membrane electrode assembly according to claim 8, wherein an amount of the element Z falls within a range of 0.01 to 40 mol % on the basis that a total molar amount of the elements X, Y and Z is set at 100 mol %.

10. The membrane electrode assembly according to claim 7, wherein a loading rate of the proton conductive inorganic material falls within a range of 80% to 98% of a porosity of the porous membrane.

11. The membrane electrode assembly according to claim 7, wherein the electrolyte membrane is obtained by impregnating the porous membrane with a precursor solution containing the element X and the element Y, followed by applying a heat treatment to the porous membrane impregnated with the precursor solution at the temperature falling within a range of 200° C. to 1,000° C.

12. The membrane electrode assembly according to claim 7, wherein the proton conductive inorganic material has a solid super strong acidity in which a Hammett acidity function H₀ satisfies −20.00≦H₀<−11.93.

13. A fuel cell, comprising:
a fuel electrode;
an oxidizing electrode; and
an electrolyte membrane arranged between the fuel electrode and the oxidizing electrode and including a porous membrane and a proton conductive inorganic material which is loaded in the porous membrane, has a super strong acidity, and contains a first oxide and a second oxide bonded to the first oxide, the first oxide containing an element X formed of at least one element selected from the group consisting of Ti, Zr, Hf, Nb, Al, Ga, In, Si, Ge, Sn and Ce, and the second oxide containing an element Y formed of at least one element selected from the group consisting of V, Cr, Me, W and B.

14. The fuel cell according to claim 13, wherein the proton conductive inorganic material further contain an element Z formed of at least one element selected from the group consisting of Y, Sc, La, Sm, Gd, Mg, Ca, Sr and Ba.

15. The fuel cell according to claim 14, wherein an amount of the element Z falls within a range of 0.01 to 40 mol % on the basis that a total molar amount of the elements X, Y and Z is set at 100 mol %.

16. The fuel cell according to claim 13, wherein a loading rate of the proton conductive inorganic material falls within a range of 80% to 98% of a porosity of the porous membrane.

17. The fuel cell according to claim 13, wherein the electrolyte membrane is obtained by impregnating the porous membrane with a precursor solution containing the element X and the element Y, followed by applying a heat treatment to the porous membrane impregnated with the precursor solution at the temperature falling within a range of 200° C. to 1,000° C.

18. The fuel cell according to claim 13, wherein the proton conductive inorganic material has a solid super strong acidity in which a Hammett acidity function H₀ satisfies −20.00≦H₀<−11.93.
